(19) United States
(12) Patent Application Publication
(10) Pub. No.: US 2011/0199591 A1
(43) Pub. Date: Aug. 18, 2011

(54) EXPOSURE APPARATUS, EXPOSING METHOD, MAINTENANCE METHOD AND DEVICE FABRICATING METHOD

(75) Inventor: Shinji SATO, Fukaya-shi (JP)

(73) Assignee: NIKON CORPORATION, Tokyo (JP)

(21) Appl. No.: 12/903,475

(22) Filed: Oct. 13, 2010

Related U.S. Application Data
(60) Provisional application No. 61/365,862, filed on Jul. 20, 2010.

(30) Foreign Application Priority Data
Oct. 14, 2009 (JP) P2009-237186

(51) Int. Cl. G03B 27/52

(52) U.S. Cl. 355/30; 355/77

(57) ABSTRACT

An exposure apparatus exposes a substrate with exposure light, which transits a first liquid. The exposure apparatus comprises: an optical member, which has an emergent surface wherefrom the exposure light emerges; a liquid immersion member, which at least partly surrounds an optical path of the exposure light emerging from the emergent surface, has a lower surface that the substrate opposes during an exposure of the substrate, and holds the first liquid between the substrate and at least part of the lower surface; and a plate member, which has a first surface and a second surface that faces the opposite direction to the first surface and which is capable of moving to a position at which it opposes the lower surface; wherein, cleaning is performed in a state wherein the first surface opposes the lower surface.

### CROSS-REFERENCE TO RELATED APPLICATION

This application is a non-provisional application claiming priority to and the benefit of U.S. Provisional Application No. 61/365,862, filed Jul. 20, 2010, and is claiming priority to Japanese Patent Application No. 2009-237186, filed on Oct. 14, 2009. The entire contents of which are incorporated herein by reference.

### BACKGROUND

1. Field of the Invention

The present invention relates to an exposure apparatus, an exposing method, a maintenance method and a device fabricating method.

2. Description of Related Art

In the process of fabricating microdevices, such as semiconductor devices and electronic devices, using an immersion exposure apparatus that exposes a substrate with exposure light through a liquid is known, as disclosed in, for example, the patent literatures (U.S. Patent Application Publication No. 2005/0055575, U.S. Patent Application Publication No. 2008/0018867, U.S. Patent Application Publication No. 2004/0211920, and U.S. Pat. No. 7,589,822).

### SUMMARY

In the immersion exposure apparatus, if a member that contacts the liquid is contaminated, then exposure failures, such as defects in the pattern formed in the substrate, might occur and, as a result, defective devices might be produced. Consequently, there is a demand for devising a technology that can satisfactorily clean a member and that can prevent the contamination of that member.

An object of aspects of the present invention is to provide an exposure apparatus, an exposing method and a maintenance method that can prevent exposure failures from occurring. Another object of aspects of the present invention is to provide a device fabricating method that can prevent defective devices from being produced.

### MEANS FOR SOLVING THE PROBLEMS

A first aspect of the present invention provides an exposure apparatus that exposes a substrate with exposure light, which transits a first liquid, and comprises: an optical member, which has an emergent surface wherefrom the exposure light emerges; a liquid immersion member, which at least partly surrounds an optical path of the exposure light emerging from the emergent surface, has a lower surface that the substrate opposes during an exposure of the substrate, and holds the first liquid between the substrate and at least part of the lower surface; and a plate member, which has a first surface and a second surface that faces the opposite direction to the first surface and which is capable of moving to a position at which it opposes the lower surface; wherein, cleaning is performed in a state wherein the first surface opposes the lower surface.

A second aspect of the present invention provides an exposure apparatus that exposes a substrate with exposure light, which transits a first liquid, and comprises: an optical member, which has an emergent surface wherefrom the exposure light emerges; a liquid immersion member, which at least partly surrounds an optical path of the exposure light emerging from the emergent surface and has a lower surface that an object disposed at a position at which it opposes the emergent surface is capable of opposing; a first movable member, which has a first upper surface and is capable of moving to a position at which the first upper surface is capable of opposing at least one surface selected from the group consisting of the emergent surface and the lower surface; a second movable member, which has a second upper surface and is capable of moving to a position at which the second upper surface opposes at least one surface selected from the group consisting of the emergent surface and the lower surface; a plate member, which is releasably held by a first holding part disposed in at least one member selected from the group consisting of the first movable member and the second movable member and which has a third upper surface; wherein, in a first process, the first liquid is held between the emergent surface and the lower surface on one side and at least one surface selected from the group consisting of the first upper surface, the second upper surface, and the third upper surface of the plate member held by the first holding part on the other side; and in a second process, which differs from the first process, a second liquid is held between the lower surface and the third upper surface of the plate member released from the first holding part.

A third aspect of the present invention provides a device fabricating method that comprises: exposing a substrate using an exposure apparatus according to first and second aspects; and developing the exposed substrate.

A fourth aspect of the present invention provides an exposing method that exposes a substrate with exposure light, which transits a first liquid, and comprises: holding the first liquid between the substrate and at least part of a lower surface of a liquid immersion member, which at least partly surrounds an optical path of the exposure light emerging from an emergent surface of an optical member; exposing the substrate with the exposure light that emerges from the emergent surface and transits the first liquid between the emergent surface and the substrate; causing the lower surface and a first upper surface of a plate member held by a holding part to oppose one another; holding the plate member, which has been released from the holding part, in the state wherein the first upper surface and the lower surface are opposed; and cleaning the lower surface in the state wherein the lower surface and the first surface are opposed.

A fifth aspect of the present invention provides an exposing method that comprises: holding a first liquid between a substrate held by a first movable member and at least part of a lower surface of a liquid immersion member, which at least partly surrounds an optical path of exposure light emerging from an emergent surface of an optical member; exposing the substrate with the exposure light that emerges from the emergent surface and transits the first liquid between the emergent surface and the substrate; in the first process, holding the first liquid between the emergent surface and the lower surface on one side and at least one surface selected from the group consisting of a first upper surface of the first movable member, a second upper surface of the second movable member, and a third upper surface of the plate member releasably held by a first holding part disposed in at least one member selected from the group consisting of the first movable member and the second movable member, on the other side; and in a second process, which is different from the first process, holding a second liquid between the lower surface and the third upper surface of the plate member released from the first holding part.

A sixth aspect of the present invention provides a device fabricating method that comprises: exposing a substrate using an exposing method according to the fourth or fifth aspects; and developing the exposed substrate.

A seventh aspect of the present invention provides a maintenance method of an exposure apparatus that exposes a substrate on a substrate stage with exposure light emerging from an emergent surface of an optical member, which transits a first liquid, that comprises: causing a lower surface of a liquid immersion member, which at least partly surrounds an optical path of the exposure light emerging from the emergent surface of the optical member and a first upper surface of a plate member held by the holding part of the substrate stage to oppose respectively; and holding the plate member released from the holding part of the substrate stage in the state wherein the first upper surface and the lower surface are opposed.

Aspects of the present invention can prevent exposure failures from occurring. In addition, the present invention makes it possible to prevent defective devices from being produced.

### BRIEF DESCRIPTION OF THE DRAWINGS

FIG. 1 is a schematic block diagram that shows one example of an exposure apparatus according to a first embodiment.

FIG. 2 is a partial plan view of the exposure apparatus according to the first embodiment.

FIG. 3 is a side cross sectional view that shows the vicinity of a liquid immersion member according to the first embodiment.

FIG. 4 is a flow chart for explaining one example of the operation of the exposure apparatus according to the first embodiment.

FIG. 5 shows one example of the operation of the exposure apparatus according to the first embodiment.

FIG. 6 shows one example of the operation of the exposure apparatus according to the first embodiment.

FIG. 7 shows one example of the operation of the exposure apparatus according to the first embodiment.

FIG. 8 shows one example of the operation of the exposure apparatus according to the first embodiment.

FIG. 9 is a diagram that shows one example of a cap member according to a second embodiment.

FIG. 10 is a diagram that shows another example of the cap member according to the second embodiment.

FIG. 11 is a diagram that shows one example of the cap member according to a third embodiment.

FIG. 12 is a diagram that shows another example of the cap member according to the third embodiment.

FIG. 13 is a diagram that shows one example of the cap member according to a fourth embodiment.

FIG. 14 is a diagram that shows another example of the cap member according to the fourth embodiment.

FIG. 15 is a diagram that shows one example of the cap member according to a fifth embodiment.

FIG. 16 is a diagram that shows one example of the cap member according to a sixth embodiment.

FIG. 17 is a schematic block diagram that shows one example of the exposure apparatus according to a seventh embodiment.

FIG. 18 is a partial plan view of the exposure apparatus according to the seventh embodiment.

FIG. 19 is a diagram that shows one example of the operation of the exposure apparatus according to the seventh embodiment.

FIG. 20 is a diagram that shows one example of the operation of the exposure apparatus according to the seventh embodiment.

FIG. 21 is a diagram that shows one example of the operation of the exposure apparatus according to the seventh embodiment.

FIG. 22 is a diagram that shows one example of the operation of the exposure apparatus according to the seventh embodiment.

FIG. 23 is a diagram that shows one example of the operation of the exposure apparatus according to the seventh embodiment.

FIG. 24 is a diagram that shows one example of the operation of the exposure apparatus according to the seventh embodiment.

FIG. 25 is a partial plan view of the exposure apparatus.

FIG. 26 is a flow chart for explaining one example of a microdevice fabricating process.

### DESCRIPTION OF THE EMBODIMENTS

The following text explains the embodiments of the present invention, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions (i.e., the vertical directions) are the Z axial directions. In addition, the rotational directions (i.e., the tilting directions) around the X, Y, and Z axes are the θX, θY, and θZ directions, respectively.

### First Embodiment

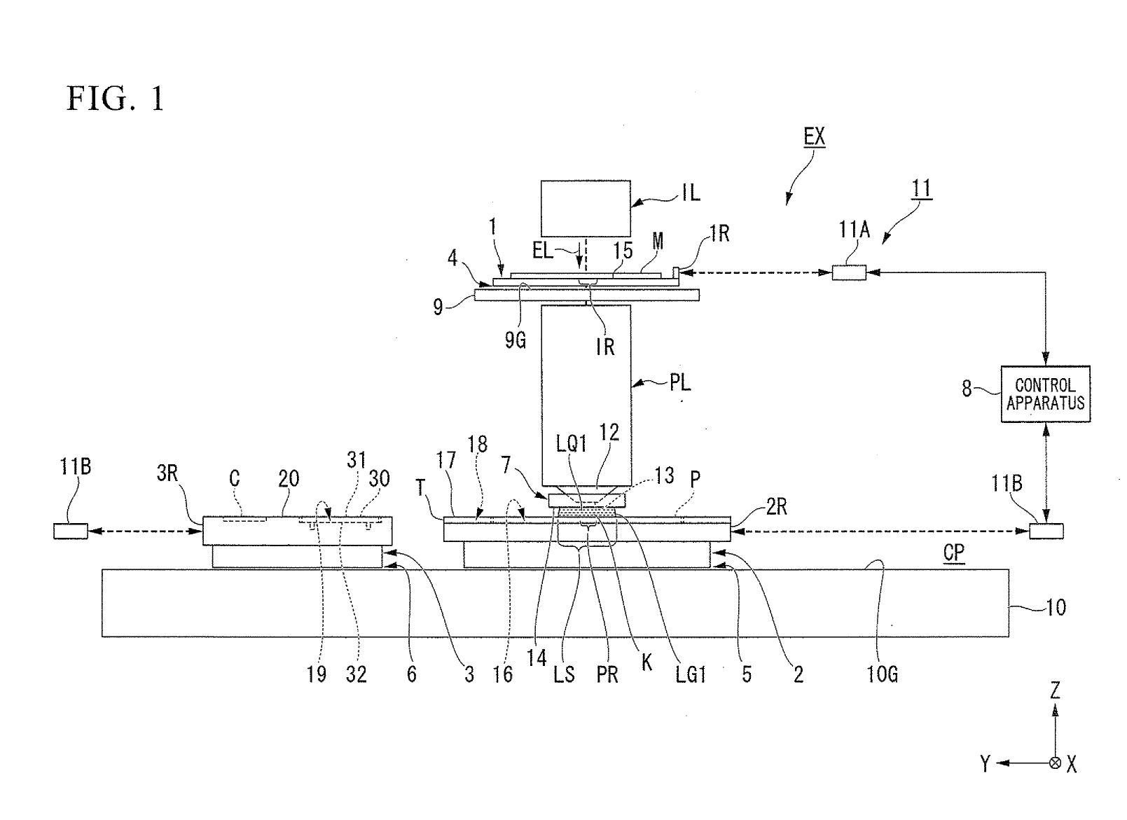

A first embodiment will now be explained. FIG. 1 is a schematic block diagram that shows one example of an exposure apparatus EX according to a first embodiment. The exposure apparatus EX of the present embodiment is an immersion exposure apparatus that exposes a substrate P with exposure light EL that transits a first liquid LQ1. In the present embodiment, an immersion space LS is formed such that at least part of the optical path of the exposure light EL is filled with the first liquid LQ1. The immersion space is a portion (i.e., a space or an area) that is filled with the liquid. The substrate P is exposed with the exposure light EL, which transits the first liquid LQ1 of the immersion space LS. In the present embodiment, water (i.e., pure water) is used as the first liquid LQ1.

In addition, the exposure apparatus EX of the present embodiment is an exposure apparatus that comprises a moveable substrate stage 2, which holds the substrate P, and a moveable measurement stage 3, which does not hold the substrate P and whereon measuring members C (i.e., measuring instruments) that measure the exposure light EL are mounted, as disclosed in, for example, U.S. Pat. No. 6,897,963 and European Patent Application Publication No. 1713113.

In FIG. 1, the exposure apparatus EX comprises: a movable mask stage 1 that holds a mask M; the substrate stage 2; the measurement stage 3; a drive system 4 that moves the mask stage 1; a drive system 5 that moves the substrate stage 2; a drive system 6 that moves the measurement stage 3; an illumination system IL that illuminates the mask M with the exposure light EL; a projection optical system PL that projects an image of a pattern of the mask M, which is illuminated by the exposure light EL, to the substrate P; a liquid immersion member 7, which is capable of forming the immersion space LS such that at least part of the optical path of the exposure light EL is filled with the first liquid LQ1; and a control apparatus 8 that controls the operation of the entire exposure apparatus EX.

In addition, the exposure apparatus EX of the present embodiment comprises a cap member 30, which is capable of moving to a position at which it opposes the liquid immersion member 7. The cap member 30 is a plate shaped member that has a first surface 31 and a second surface 32, which faces the opposite direction to the first surface 31. In the present embodiment, the exposure apparatus EX comprises a holding part 19, which is disposed on the measurement stage 3 and releasably holds the cap member 30. The cap member 30 is capable of being held and moved by the holding part 19. The holding part 19 holds the second surface 32 of the cap member 30. In the explanation below, the first surface 31 of the cap member 30 is called the upper surface 31 where appropriate, and the second surface 32 is called the lower surface 32 where appropriate.

The mask M includes a reticle on which a device pattern to be projected to the substrate P is formed. The mask M includes a transmissive mask comprising a transparent plate, such as a glass plate, and the pattern, which is formed on the transparent plate using a shielding material, such as chrome. Furthermore, the mask M may alternatively be a reflective mask.

The substrate P is a substrate for fabricating devices. The substrate P comprises, for example, a base material, such as a semiconductor wafer, and a photosensitive film, which is formed on the base material. The photosensitive film is made of a photosensitive material (e.g., photoresist). In addition to the photosensitive film, the substrate P may include a separate film. For example, the substrate P may include an antireflection film or a protective film (i.e., a topcoat film) that protects the photosensitive film.

The illumination system IL radiates the exposure light EL to a prescribed illumination area IR. The illumination area IR includes a position whereto the exposure light EL that emerges from the illumination system IL can be radiated. The illumination system IL illuminates at least part of the mask M disposed in the illumination area IR with the exposure light EL, which has a uniform luminous flux intensity distribution. Examples of light that can be used as the exposure light EL emitted from the illumination system IL include: deep ultraviolet (DUV) light, such as a bright line (i.e., g-line, h-line, or i-line) light emitted from, for example, a mercury lamp, and KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

The mask stage 1 comprises a mask holding part 15 that releasably holds the mask M. In the state wherein it holds the mask M, the mask stage 1 is capable of moving on a guide surface 9G of a base member 9 that includes the illumination area IR. In the present embodiment, the guide surface 9G is substantially parallel to the XY plane. The drive system 4 comprises a planar motor for moving the mask stage 1 on the guide surface 9G. The planar motor comprises a slider, which is disposed on the mask stage 1, and a stator, which is disposed on the base member 9, as disclosed in, for example, U.S. Pat. No. 6,452,292. In the present embodiment, the mask stage 1 is capable of moving in six directions, namely, the X axial, Y axial, Z axial, θX, θY, and θZ directions, along the guide surface 9G by the operation of the drive system 4.

The projection optical system PL radiates the exposure light EL to a prescribed projection area PR. The projection area PR includes a position whereto the exposure light EL that emerges from the projection optical system PL can be radiated. In the present embodiment, an optical axis of the projection optical system PL is substantially parallel to the Z axis. The projection optical system PL projects with a prescribed projection magnification an image of the pattern of the mask M to at least part of the substrate P, which is disposed in the projection area PR. The projection optical system PL of the present embodiment is a reduction system that has a projection magnification of, for example, ¼, ⅕, or ⅛. Furthermore, the projection optical system PL may be a unity magnification system or an enlargement system. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

The projection optical system PL has an emergent surface 13 wherefrom the exposure light EL emerges and travels toward an image plane of the projection optical system PL. A last optical element 12, which is the optical element among the plurality of optical elements of the projection optical system PL that is closest to the image plane of the projection optical system PL, has the emergent surface 13. In the present embodiment, the emergent surface 13 faces the −Z direction (i.e., downward) and is parallel to the XY plane. Furthermore, the emergent surface 13, which faces the −Z direction, may be a convex or a concave surface.

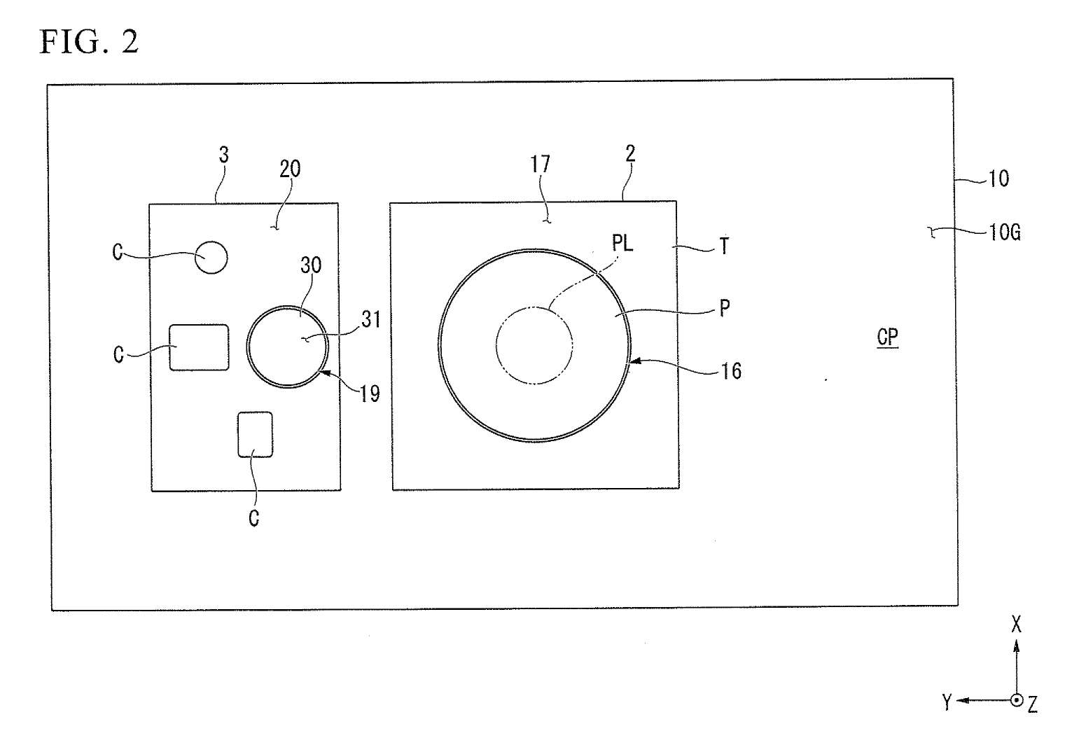

Next, the substrate stage 2 and the measurement stage 3 will be explained. FIG. 2 is a plan view from above of the substrate stage 2 and the measurement stage 3.

As shown in FIG. 1 and FIG. 2, the substrate stage 2 comprises a substrate holding part 16, which releasably holds the substrate P, and has an upper surface 17, which is disposed around the substrate holding part 16. In the present embodiment, as disclosed in U.S. Patent Application Publication No. 2007/0177125, the substrate stage 2 comprises a plate member holding part 18, which is disposed at least partly around the substrate holding part 16 and releasably holds a lower surface of a plate member T. The plate member holding part 18 at least partly surrounds the substrate holding part 16. In the present embodiment, the upper surface 17 of the substrate stage 2 includes an upper surface of the plate member T. In the present embodiment, the upper surface 17 is flat. Furthermore, the plate member T does not have to be releasable. In such a case, the plate member holding part 18 could be omitted.

In the present embodiment, the substrate holding part 16 holds the substrate P such that a front surface of the substrate P is substantially parallel to the XY plane. In addition, in the present embodiment, the upper surface 17 of the substrate stage 2 is substantially parallel to the XY plane. In addition, in the present embodiment, the front surface of the substrate P, which is held by the substrate holding part 16, and the upper surface 17 of the substrate stage 2 are disposed within the same plane (i.e., they are flush with one another). Furthermore, the front surface of the substrate P held by the substrate holding part 16 and the upper surface 17 do not have to be disposed within the same plane. In addition, the front surface of the substrate P held by the substrate holding part 16 or the upper surface 17, or both, may be nonparallel with respect to the XY plane.

The measurement stage 3 comprises the holding part 19, which releasably holds the cap member 30, and has an upper surface 20, which is disposed around the holding part 19. In the present embodiment, the upper surface 20 of the measurement stage 3 includes upper surfaces of the measuring members C. In the present embodiment, the upper surface 20 is flat.

In the present embodiment, the holding part 19 holds the cap member 30 such that the upper surface 31 of the cap member 30 is substantially parallel to the XY plane. In addition, in the present embodiment, the upper surface 20 of the measurement stage 3 is substantially parallel to the XY plane. In addition, in the present embodiment, the upper surface 31 of the cap member 30 held by the holding part 19 and the upper surface 20 of the measurement stage 3 are disposed within the same plane (i.e., they are flush with one another). Furthermore, the upper surface 31 of the cap member 30 held by the holding part 19 and the upper surface 20 do not have to be disposed within the same plane. In addition, the upper surface 31 of the cap member 30 held by the holding part 19 or the upper surface 20, or both, may be nonparallel to the XY plane.

In the state wherein it holds the substrate P, the substrate stage 2 is capable of moving on a guide surface 10G of a base member 10, which includes the projection area PR. The measurement stage 3 is capable of moving on the guide surface 10G of the base member 10, which includes the projection area PR, in the state wherein the measuring members C (i.e., the measuring instruments) and the cap member 30 are mounted thereupon. In the present embodiment, the guide surface 10G is substantially parallel to the XY plane.

The drive system 5 for moving the substrate stage 2 includes a planar motor for moving the substrate stage 2 on the guide surface 10G The planar motor comprises a slider, which is disposed on the substrate stage 2, and a stator, which is disposed on the base member 10, as disclosed in, for example, U.S. Pat. No. 6,452,292. The drive system 6 for moving the measurement stage 3 likewise comprises a planar motor; the planar motor comprises a slider, which is disposed on the measurement stage 3, and a stator, which is disposed on the base member 10.

In the present embodiment, an interferometer system 11, which comprises laser interferometer units 11A, 11B, measures the positions of the mask stage 1, the substrate stage 2, and the measurement stage 3. The laser interferometer units 11A are capable of measuring the position of the mask stage 1 using measurement mirrors 1R, which are disposed on the mask stage 1. The laser interferometer units 11B are capable of measuring the positions of the substrate stage 2 and the measurement stage 3 using measurement mirrors 2R, which are disposed on the substrate stage 2, and measurement mirrors 3R, which are disposed on the measurement stage 3. When an exposing process or a prescribed measuring process is performed on the substrate P, the control apparatus 8 controls the positions of the mask stage 1 (i.e., the mask M), the substrate stage 2 (i.e., the substrate P), and the measurement stage 3 (i.e., the measuring members) by operating the drive systems 4, 5, 6 based on the measurement results of the interferometer system 11.

The liquid immersion member 7 is capable of forming the immersion space LS such that at least part of the optical path of the exposure light EL is filled with the first liquid LQ1. The liquid immersion member 7 is disposed in the vicinity of the last optical element 12. In the present embodiment, the liquid immersion member 7 is disposed at least partly around an optical path K of the exposure light EL emerging from the emergent surface 13. The liquid immersion member 7 at least partly surrounds the optical path K of the exposure light EL. In the present embodiment, the liquid immersion member 7 is an annular member and is disposed around the optical path K of the exposure light EL. In addition, in the present embodiment, at least part of the liquid immersion member 7 is disposed around the last optical element 12.

The liquid immersion member 7 can form the immersion space LS such that the optical path K of the exposure light EL that emerges from the emergent surface 13 is filled with the first liquid LQ1. In the present embodiment, the immersion space LS is formed such that the optical path K of the exposure light EL between the emergent surface 13 and an object, which is disposed at a position at which it opposes the emergent surface 13, is filled with the first liquid LQ1. In the present embodiment, the position at which the object opposes the emergent surface 13 includes a position (i.e., the projection area PR) whereto the exposure light EL that emerges from the emergent surface 13 can be radiated. In the present embodiment, the object that is capable of being disposed at a position at which it opposes the emergent surface 13 includes those objects on the image plane side of the projection optical system PL (i.e., on the emergent surface 13 side of the last optical element 12) that are capable of moving on the guide surface 10G that includes the position (i.e., the projection area PR) at which the object opposes the emergent surface 13. In the present embodiment, the object includes at least one member selected from the group consisting of: the substrate stage 2; the substrate P, which is held by the substrate stage 2; the measurement stage 3; the measuring instruments C, which are mounted on the measurement stage 3; and the cap member 30, which is held by the measurement stage 3.

In the present embodiment, the liquid immersion member 7 has a lower surface 14, which is capable of opposing the upper surface (i.e., the front surface) of the object disposed at the position (i.e., the projection area PR) at which the object opposes the emergent surface 13. The lower surface 14 at least partly surrounds the optical path K of the exposure light EL emerging from the emergent surface 13. The lower surface 14 at least partly surrounds the optical path K of the exposure light EL. In the present embodiment, the lower surface 14 is disposed around the optical path K. Furthermore, the lower surface 14 may be disposed partly around the optical path K. The liquid immersion member 7 can hold the first liquid LQ1 between itself and the object disposed at the position at which the object opposes the emergent surface 13. In addition, the object disposed at the position at which it opposes the emergent surface 13 can oppose at least part of the lower surface 14. Holding the first liquid LQ1 between the emergent surface 13 and the lower surface 14 on one side and the upper surface of the object on the other side forms the immersion space LS such that the optical path K of the exposure light EL between the last optical element 12 and the object is filled with the first liquid LQ1. Furthermore, in the present embodiment, the lower surface 14 is substantially flat, but part of the lower surface 14 may be a step, an inclined surface, a curved surface, or any combination thereof. In addition, the lower surface 14 may be inclined with respect to, instead of parallel to, the XY plane.

During an exposure of the substrate P, the front surface of the substrate P opposes the lower surface 14 of the liquid immersion member 7. During the exposure of the substrate P, the liquid immersion member 7 can hold the first liquid LQ1 between the substrate P and at least part of the lower surface 14. In the present embodiment, when the substrate P is irradiated with the exposure light EL, the immersion space LS is already formed such that part of the area of the front surface of the substrate P that includes the projection area PR is covered with the first liquid LQ1. At least part of an interface LG1 (i.e., a meniscus or an edge) of the first liquid LQ1 is formed between the lower surface 14 of the liquid immersion member 7 and the front surface of the substrate P. The exposure apparatus EX of the present embodiment adopts a local liquid immersion system.

The substrate stage 2 and the measurement stage 3 are each capable of moving on the guide surface 10G, which includes the position at which the substrate stage 2 or the measurement stage 3 opposes the emergent surface 13 and the lower surface 14. The upper surface 17 of the substrate stage 2 is capable of opposing the emergent surface 13 and the lower surface 14. The upper surface 17 is capable of holding the first liquid LQ1 between itself and the emergent surface 13 and the lower surface 14. The upper surface 20 of the measurement stage 3 is capable of opposing the emergent surface 13 and the lower surface 14. The upper surface 20 is capable of holding the first liquid LQ1 between itself and the emergent surface 13 and the lower surface 14.

The upper surface 31 of the cap member 30 is capable of opposing the emergent surface 13 and the lower surface 14. The cap member 30 is capable of moving to a position at which it opposes the emergent surface 13 and the lower surface 14. The cap member 30 is held by the holding part 19, which is disposed on the measurement stage 3, and is capable of moving to the position at which it opposes the emergent surface 13 and the lower surface 14. The upper surface 31 is capable of holding the first liquid LQ1 between itself and the emergent surface 13 and the lower surface 14.

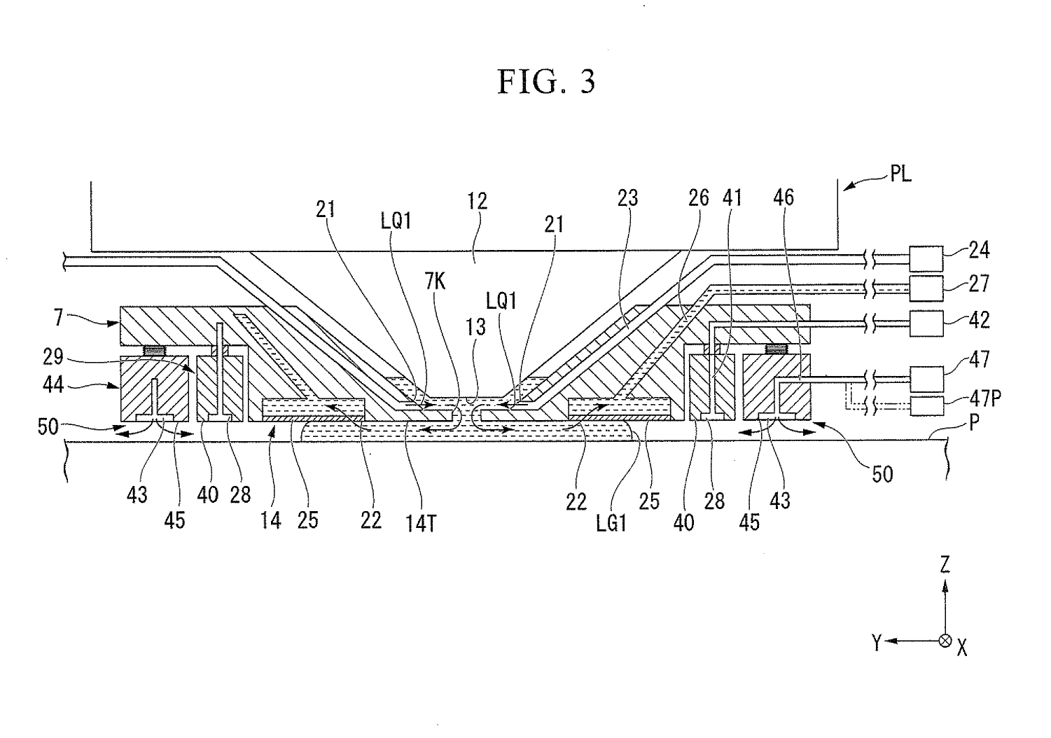

FIG. 3 is a side cross sectional view that shows one example of a liquid immersion member 7 according to the present embodiment. Furthermore, the text referencing FIG. 3 explains an exemplary case wherein the substrate P is disposed in the projection area PR (i.e., at a position at which it opposes the last optical element 12 and the liquid immersion member 7), but the substrate stage 2 or the measurement stage 3, or both, can also be disposed in the projection area PR.

As shown in FIG. 3, the liquid immersion member 7 has an opening 7K positioned such that it opposes the emergent surface 13. The exposure light EL that emerges from the emergent surface 13 can be radiated through the opening 7K to the substrate P. The lower surface 14 is disposed around the opening 7K.

In addition, the liquid immersion member 7 includes first supply ports 21, which are capable of supplying the first liquid LQ1, and first recovery ports 22, which are capable of recovering the first liquid LQ1. At least during the exposure of the substrate P, the first supply ports 21 supply the first liquid LQ1 and the first recovery ports 22 recover at least some of the first liquid LQ1.

The first supply ports 21 supply the first liquid LQ1 to the optical path K of the exposure light EL emerging from the emergent surface 13. The first supply ports 21 are disposed in the vicinity of the optical path K of the exposure light EL such that they face the optical path K.

The first supply ports 21 are connected to a liquid supply apparatus 24 via passageways 23. The liquid supply apparatus 24 comprises a filter unit, which is for eliminating foreign matter in the first liquid LQ1 to be supplied, and a temperature adjusting apparatus, which is capable of adjusting the temperature of the first liquid LQ1 to be supplied; furthermore, the liquid supply apparatus 24 is capable of supplying the first liquid LQ1 such that the first liquid LQ1 is clean and temperature adjusted. Each of the passageways 23 includes a supply passageway, which is formed inside the liquid immersion member 7, and a passageway, which comprises a supply pipe that connects the supply passageway and the liquid supply apparatus 24. The first liquid LQ1 supplied from the liquid supply apparatus 24 is supplied to the first supply ports 21 via the passageways 23.

The first recovery port 22 is capable of recovering at least some of the first liquid LQ1 on the substrate P (i.e., the object) opposing the lower surface 14 of the liquid immersion member 7. The first recovery port 22 is capable of recovering at least some of the first liquid LQ1 between the lower surface 14 and the substrate P (i.e., the object). The first recovery port 22 is disposed at a prescribed position of the liquid immersion member 7 such that the first recovery port 22 opposes the front surface of the object. The first recovery port 22 is disposed in at least part of the lower surface 14. The first recovery port 22 is disposed at least partly around the opening 7K where through the exposure light EL passes. The first recovery port 22 at least partly surrounds the opening 7K. The first recovery port 22 is disposed on the outer side of the first supply ports 21 in radial directions with respect to the optical path K. In the present embodiment, the first recovery port 22 is disposed continuously around the opening 7K. Furthermore, the first recovery port 22 may be disposed noncontinuously around the opening 7K.

A plate shaped porous member 25, which has a plurality of holes (i.e., openings or pores), is disposed in the first recovery port 22. Furthermore, a mesh filter, which is a porous member wherein numerous small holes are formed as a mesh, may be disposed in the first recovery port 22. In addition, the porous member 25 does not have to be disposed in the first recovery port 22.

In the present embodiment, the lower surface 14 includes the front surface (i.e., the lower surface) of the porous member 25 disposed in the first recovery port 22. In the present embodiment, the lower surface 14 includes a flat surface 14T, which is disposed around the opening 7K, and the front surface of the porous member 25, which is disposed at least partly around the flat surface 14T. The porous member 25 at least partly surrounds the flat surface 14T.

The first recovery port 22 is connected to a first liquid recovery apparatus 27 via a passageway 26. The first liquid recovery apparatus 27 is capable of connecting the first recovery port 22 to a vacuum system and is capable of sucking the first liquid LQ1 via the first recovery port 22. The passageway 26 comprises a recovery passageway, which is formed inside the liquid immersion member 7, and a passageway, which comprises a recovery pipe that connects the recovery passageway and the first liquid recovery apparatus 27. The first liquid LQ1 recovered via the first recovery port 22 is recovered by the first liquid recovery apparatus 27 via the passageway 26.

At least during an exposure of the substrate P, the first liquid LQ1 is supplied via the first supply ports 21; however, in parallel with the operation of supplying the first liquid LQ1 via the first supply ports 21, the operation of recovering the first liquid LQ1 via the first recovery port 22 is performed. By performing the operation of recovering the first liquid LQ1 via the first recovery port 22 in parallel with the operation of supplying the first liquid LQ1 via the first supply ports 21, the control apparatus 8 can form the immersion space LS with the first liquid LQ1 between the last optical element 12 and the liquid immersion member 7 on one side and the object on the other side.

In addition, in the present embodiment, the liquid supply apparatus 24 is capable of supplying a second liquid LQ2. The second liquid LQ2 can be supplied via the first supply ports 21, which are disposed in the liquid immersion member 7. The second liquid LQ2 is a cleaning liquid for cleaning prescribed members inside the exposure apparatus EX. In the present embodiment, the second liquid LQ2 is different from the first liquid LQ1. In the present embodiment, the second liquid LQ2 is an alkali cleaning liquid. In the present embodiment, an alkali aqueous solution is used as the second liquid LQ2. In the present embodiment, the second liquid LQ2 is an aqueous solution of tetramethylammonium hydroxide (TMAH).

Furthermore, the second liquid LQ2 may be alcohol. For example, the second liquid LQ2 may be at least of ethanol, isopropyl alcohol (IPA), and pentanol.

In addition, in the present embodiment, a second recovery port 28, which is capable of recovering the first liquid LQ1, is provided. The second recovery port 28 is disposed on the outer side of the first recovery port 22 in radial directions with respect to the optical path K. The second recovery port 28 is disposed in a recovery member 29. The recovery member 29 has a lower surface 40 that is capable of opposing the front surface of the substrate P (i.e., the object) disposed in the projection area PR. The second recovery port 28 is disposed at least partly in the lower surface 40. The lower surface 40 is disposed at least partly around the lower surface 14. The lower surface 40 at least partly surrounds the lower surface 14. In the present embodiment, the recovery member 29 is an annular member, and the lower surface 40 is disposed around the lower surface 14. In the present embodiment, the second recovery port 28 is annular and disposed around the first recovery port 22. Furthermore, multiple second recovery ports 28 may be disposed at prescribed spacings such that they surround the first recovery port 22. Furthermore, the lower surface 40 is disposed partly around the lower surface 14. At least during the exposure of the substrate P, the front surface of the substrate P opposes the second recovery port 28, which is disposed in the lower surface 40.

During an exposure of the substrate P, the second recovery port 28 is capable of recovering the first liquid LQ1. During an exposure of the substrate P, the interface LG1 of the first liquid LQ1 in the immersion space LS is disposed between the lower surface 14 of the liquid immersion member 7 and the front surface of the substrate P. In the normal state wherein the interface LG1 is disposed between the lower surface 14 of the liquid immersion member 7 and the front surface of the substrate P, the first liquid LQ1 in the immersion space LS does not flow into the space between the lower surface 40 of the recovery member 29 and the front surface of the substrate P, and the second recovery port 28 does not recover the first liquid LQ1. Nevertheless, there is a possibility that the first liquid LQ1 in the immersion space LS will adversely flow out of the space between the lower surface 14 of the liquid immersion member 7 and the front surface of the substrate P owing to, for example, the movement conditions (i.e., the movement velocity, the acceleration, the movement distance, and the like) of the substrate P, the state of the front surface of the substrate P, and the like. The second recovery port 28 is capable of recovering the first liquid LQ1 that flows out of the space between the lower surface 14 of the liquid immersion member 7 and the front surface of the substrate P and flows into the space between the lower surface 40 of the recovery member 29 and the front surface of the substrate P. In addition, the second recovery port 28 can also recover the first liquid LQ1 that was not completely recovered via the first recovery port 22 and therefore remains on the substrate P. Providing the second recovery port 28 prevents the first liquid LQ1 from leaking, from remaining on the substrate P, and the like.

The second recovery port 28 is connected to a second liquid recovery apparatus 42 via a passageway 41. The second liquid recovery apparatus 42 is capable of connecting the second recovery port 28 to a vacuum system and is capable of sucking the first liquid LQ1 via the second recovery port 28. The passageway 41 includes a recovery passageway, which is formed inside the recovery member 29, and a passageway, which comprises a recovery pipe that connects the recovery passageway and the second liquid recovery apparatus 42. The first liquid LQ1 recovered via the second recovery port 28 is recovered by the second liquid recovery apparatus 42 via the passageway 41.

In addition, in the present embodiment, an opening 43 (i.e., a gas supply port), which is capable of supplying a gas, is provided. The opening 43 is disposed on the outer side of the second recovery port 28 in radial directions with respect to the optical path K. The opening 43 is disposed in a prescribed member 44. The prescribed member 44 has a lower surface 45 that is capable of opposing the front surface of the substrate P (i.e., the object) disposed in the projection area PR. The opening 43 is disposed at least partly in the lower surface 45. The lower surface 45 is disposed at least partly around the lower surface 14 and the lower surface 40. The lower surface 45 at least partly surrounds the lower surface 14 and the lower surface 40. In the present embodiment, the prescribed member 44 is an annular member, and the lower surface 45 is disposed around the lower surface 14 and the lower surface 40. In the present embodiment, the opening 43 is annular and disposed around the second recovery port 28. Furthermore, multiple openings 43 may be disposed at prescribed spacings such that they surround the second recovery port 28. Furthermore, the lower surface 45 may be disposed partly around the lower surface 14 and the lower surface 40. At least during an exposure of the substrate P, the front surface of the substrate P opposes the opening 43, which is disposed in the lower surface 45.

During the exposure of the substrate P, the gas is supplied via the opening 43. At least some of the gas supplied via the opening 43 flows between the lower surface 45 and the front surface of the substrate P and is supplied to the interface LG1 of the first liquid LQ1 in the immersion space LS. The interface LG1 is disposed between the lower surface 14 of the liquid immersion member 7 and the front surface of the substrate P. At least some of the gas supplied via the opening 43 flows from the outer side of the immersion space LS to the interface LG1. That gas flow prevents the first liquid LQ1 from leaking out of the space between the lower surface 14 and the front surface of the substrate P. Namely, at least some of the gas supplied via the opening 43 forms a gas seal that prevents the first liquid LQ1 in the immersion space LS from leaking out.

The opening 43 is connected to a gas supply apparatus 47 via a passageway 46. The gas supply apparatus 47 is capable of supplying the gas, which is clean and temperature adjusted. The passageway 46 includes an internal passageway of the prescribed member 44 and a passageway, which has a pipe that connects the internal passageway and the gas supply apparatus 47. The gas supplied from the gas supply apparatus 47 is supplied to the opening 43 via the passageway 46.

In addition, in the present embodiment, the opening 43 is capable of being connected to a suction apparatus 47P via at least part of the passageway 46. The suction apparatus 47P comprises a vacuum system and is capable of sucking the gas around the opening 43 via the opening 43. Namely, in the present embodiment, the opening 43 functions as a gas supply port and as a suction port (i.e., a gas suction port).

The prescribed member 44 can releasably hold the cap member 30 such that the upper surface 31 and the lower surface 14 are opposed respectively. In the state wherein the lower surface 45 of the prescribed member 44 and at least part of the upper surface 31 of the cap member 30 are in contact, the suction operation is performed via the opening 43, which chucks (sorbs and holds) the cap member 30 to the lower surface 45 of the prescribed member 44. Canceling the suction operation via the opening 43 releases the cap member 30 from the prescribed member 44. Thus, in the present embodiment, the lower surface 45 of the prescribed member 44, which is disposed at least partly around the lower surface 14 of the liquid immersion member 7, and the opening 43 (i.e., the suction port), which is disposed in the lower surface 45, together function as a holding part that releasably holds the cap member 30 such that the upper surface 31 and the lower surface 14 are opposed. In the explanation below, the prescribed member 44 (i.e., the lower surface 45), which releasably holds the cap member 30 such that the upper surface 31 and the lower surface 14 are opposed, is called a holding part 50 where appropriate. Furthermore, when the cap member 30 is held by the holding part 50, the lower surface 45 and the upper surface 31 do not have to make contact. For example, both the gas supply port and the gas suction port may be provided to the prescribed member 44 and the cap member 30 may be held by the holding part 50 in the state wherein the lower surface 45 and the upper surface 31 do not make contact. In addition, the holding part 50 may hold (support) the cap member 30 such that the holding part 50 contacts with the lower surface 32 (and/or a side surface) of the cap member 30.

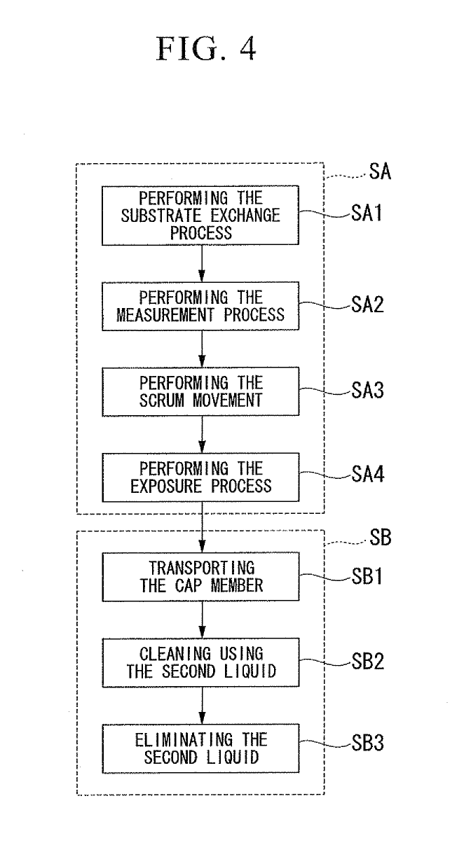

One example of the operation of the exposure apparatus EX with the configuration discussed above will now be explained, referencing the flow chart in FIG. 4.

In the present embodiment, a first process (i.e., a step SA) and a second process (i.e., a step SB), which is different from the first process, are performed. The first process includes a substrate P exchanging process (i.e., a step SA1), an exposure light EL measuring process (i.e., a step SA2), and a substrate P exposing process (i.e., a step SA4). The second process includes cleaning (i.e., a step SB2). In the explanation below, the first process is called an exposure sequence where appropriate, and the second process is called a maintenance sequence where appropriate.

To load the unexposed substrate P onto the substrate stage 2, the control apparatus 8 moves the substrate stage 2 to a substrate exchange position CR The substrate exchange position CP is a position that is different from the position at which it opposes the emergent surface 13 and the lower surface 14. The substrate exchange position CP is a position spaced apart from the liquid immersion member 7 (i.e., the projection area PR) and is where the substrate P exchanging process can be performed. The substrate P exchanging process includes at least one process selected from the group consisting of a process that unloads the exposed substrate P, which is held by the substrate stage 2, from the substrate stage 2 using a substrate transport apparatus (not shown), and a process that loads the unexposed substrate P onto the substrate stage 2. The control apparatus 8 moves the substrate stage 2 to the substrate exchange position CP and performs the substrate P exchanging process (i.e., the step SA1).

When the substrate stage 2 is moved to the substrate exchange position CP, the control apparatus 8 forms the immersion space LS by disposing the upper surface 20 of the measurement stage 3 or the upper surface 31 of the cap member 30 held by the holding part 19, or both, at a position at which the upper surface 20 or the upper surface 31 opposes the emergent surface 13 and the lower surface 14 and by holding the first liquid LQ1 between the lower surface 14 and the emergent surface 13, on one side, and the upper surface 20 or the upper surface 31, or both, on the other side.

In addition, during at least part of the interval during which the substrate stage 2 is spaced apart from the liquid immersion member 7, the measuring process is performed, as needed, using the measurement stage 3 (i.e., the step SA2). When the measuring process is performed using the measurement stage 3, the control apparatus 8 causes the emergent surface 13 and the lower surface 14 on one side and the upper surface 20 on the other side to oppose one another and forms the immersion space LS such that the optical path K between the last optical element 12 and the measuring members C is filled with the first liquid LQ1. The control apparatus 8 performs the exposure light EL measuring process by radiating the exposure light EL through the projection optical system PL and the first liquid LQ1 to the measuring members C (i.e., the measuring instruments) held by the measurement stage 3. The result of that measuring process is reflected in the substrate P exposing process to be subsequently performed.

After the unexposed substrate P has been loaded onto the substrate stage 2 and the measuring process using the measurement stage 3 is complete, the control apparatus 8 forms the immersion space LS by moving the substrate stage 2 to the projection area PR, disposing the upper surface 17 at a position at which it opposes the emergent surface 13 and the lower surface 14, and holding the first liquid LQ1 between the emergent surface 13 and the lower surface 14 on one side and the upper surface 17 (or the front surface of the substrate P) on the other side.

In the present embodiment, the control apparatus 8 can, in a first process, synchronously move the substrate stage 2 and the measurement stage 3 in the X and Y directions with respect to the emergent surface 13 and the lower surface 14 while, at the same time, causing the emergent surface 13 and the lower surface 14 to oppose either the upper surface 17 or the upper surface 20, or both, in the state wherein an edge of the upper surface 17 and an edge of the upper surface 20 are brought into proximity or contact with one another such that a space is continuously formed that can hold the first liquid LQ1 between the emergent surface 13 and the lower surface 14 on one side and the upper surface 17 or the upper surface 20, or both, on the other side, as disclosed in, for example, U.S. Patent Application Publication No. 2006/0023186 and U.S. Patent Application Publication No. 2007/0127006 (i.e., a step SA3).

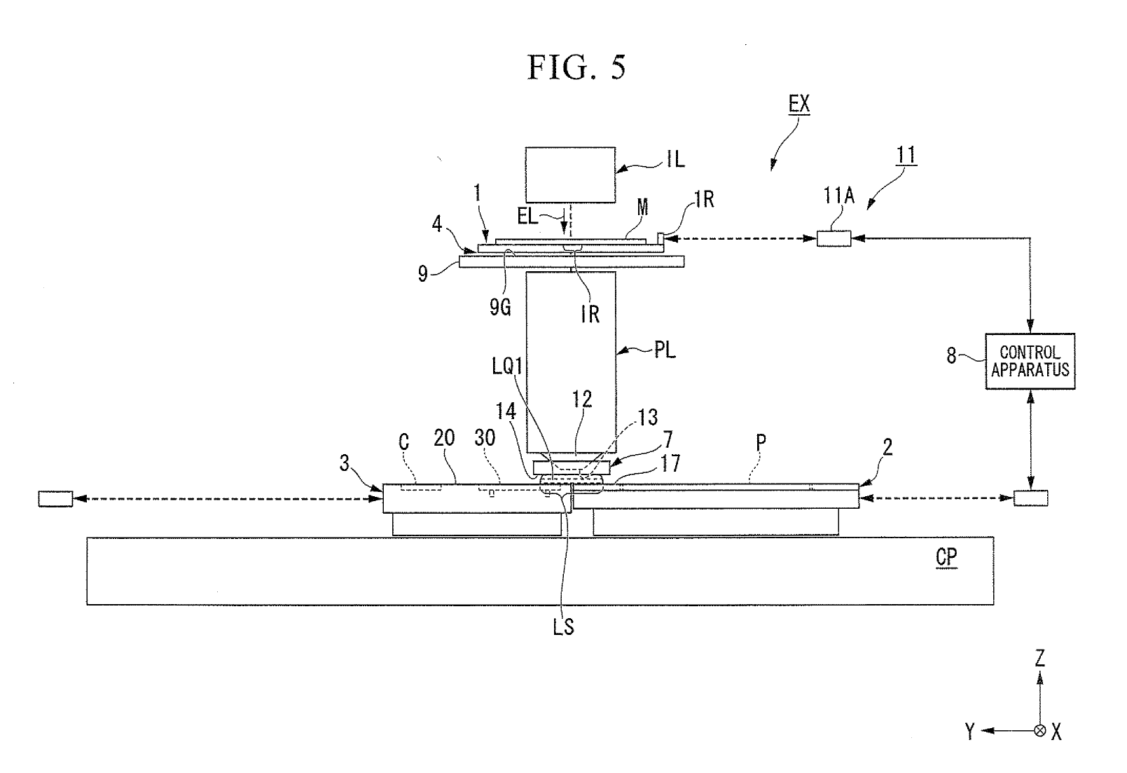

Thereby, as shown in FIG. 5, the control apparatus 8 can switch between the state wherein the immersion space LS can be formed between the last optical element 12 and the liquid immersion member 7 on one side and the substrate stage 2 on the other side and the state wherein the immersion space LS can be formed between the last optical element 12 and the liquid immersion member 7 on one side and the measurement stage 3 on the other side. Namely, the control apparatus 8 can move the substrate stage 2 and the measurement stage 3 with respect to the last optical element 12 and the liquid immersion member 7 such that, while preventing leakage of the first liquid LQ1, the immersion space LS formed on the lower surface 14 side of the liquid immersion member 7 moves between the space above the upper surface 17 of the substrate stage 2 and the space above the upper surface 20 of the measurement stage 3. Namely, while maintaining the state wherein the optical path on the emergent surface side of the projection optical system PL (i.e., the last optical element 12) is filled with the first liquid LQ1, it is possible to switch between the state wherein the immersion space LS is formed between the last optical element 12 and the liquid immersion member 7 on one side and the substrate stage 2 on the other side and the state wherein the immersion space LS is formed between the last optical element 12 and the liquid immersion member 7 on one side and the measurement stage 3 on the other side.

In the explanation below, the operation of synchronously moving the substrate stage 2 and the measurement stage 3 in the X and Y directions with respect to the emergent surface 13 of the last optical element 12 and the lower surface 14 of the liquid immersion member 7 in the state wherein the upper surface 17 of the substrate stage 2 and the upper surface 20 of the measurement stage 3 are brought into proximity or contact with one another is called a “rugby scrum” movement where appropriate.

After the immersion space LS is formed by performing the “rugby scrum” movement—that is, by causing the emergent surface 13 and the lower surface 14 on one side and the front surface of the substrate P on the other side to be opposed—and by holding the first liquid LQ1 between the front surface of the substrate P on one side and at least part of the emergent surface 13 and the lower surface 14 on the other side such that the optical path K of the exposure light EL between the emergent surface 13 and the front surface of the substrate P is filled with the first liquid LQ1, the control apparatus 8 starts the substrate P exposing process (i.e., the step SA4).

The control apparatus 8 radiates the exposure light EL, which emerges from the mask M illuminated with the exposure light EL from the illumination system IL, to the substrate P through the projection optical system PL and the first liquid LQ1 in the immersion space LS. Thereby, the substrate P is exposed with the exposure light EL, which emerges from the emergent surface 13 and transits the first liquid LQ1 between the emergent surface 13 and the substrate P, and an image of the pattern on the mask M is projected to the substrate P.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. In the present embodiment, the scanning directions (i.e., the synchronous movement directions) of both the substrate P and the mask M are the Y axial directions. The control apparatus 8 both moves the substrate P in the Y axial directions with respect to the projection area PR of the projection optical system PL and radiates the exposure light EL to the substrate P through the projection optical system PL and the first liquid LQ1 in the immersion space LS on the substrate P while, at the same time, moving the mask M in the Y axial direction with respect to the illumination area IR of the illumination system IL in synchronization with the movement of the substrate P in the Y axial direction.

After the substrate P exposing process is complete, the control apparatus 8 performs the “rugby scrum” movement and moves the substrate stage 2 to the substrate exchange position CR The measurement stage 3 is disposed in, for example, the projection area PR, and the first liquid LQ1 is held between the emergent surface 13 and the measurement stage 3. The control apparatus 8 unloads the exposed substrate P from the substrate stage 2, which has moved to the substrate exchange position CP, and the unexposed substrate P is loaded onto the substrate stage 2.

Below, the control apparatus 8 performs the processes discussed above repetitively to sequentially expose a plurality of substrates P.

Furthermore, in the present embodiment, during at least part of the exposure sequence (i.e., the step SA), which includes the substrate P exchanging process, the measuring process wherein the measurement stage 3 is used, and the substrate P exposing process, the first liquid LQ1 is supplied via the first supply ports 21 to the optical path K of the exposure light EL and to above the substrate P and at least some of the first liquid LQ1 on the substrate P is recovered via the first recovery port 22. In addition, during at least part of the exposure sequence, the recovery operation via the second recovery port 28 is performed. In addition, during at least part of the exposure sequence, the gas supplying operation via the opening 43 is performed. In the present embodiment, while the liquid recovery operation (i.e., the suction operation) via the first recovery port 22 is being performed, the liquid recovery operation (i.e., the suction operation) via the second recovery port 28 continues. If the first liquid LQ1 is not present on the substrate P opposing the second recovery port 28, then the second recovery port 28 sucks the peripheral gas. However, if the first liquid LQ1 is present on the substrate P opposing the second recovery port 28, then the second recovery port 28 recovers the first liquid LQ1 on the substrate P. In addition, during at least part of the exposure sequence, the second liquid LQ2 is not supplied from the liquid supply apparatus 24.

Furthermore, in FIG. 3, the lower surface 14 of the liquid immersion member 7, the lower surface 40 of the recovery member 29, and the lower surface 45 of the prescribed member 44 are disposed within substantially the same plane, but the positions of the lower surface 14, the lower surface 40, and the lower surface 45 in the Z axial directions may be different. For example, the positions of each of the three lower surfaces (14, 40, 45) in the Z axial directions may be different, the position of one of the three lower surfaces (14, 40, 45) in the Z axial directions may be different from the other lower surfaces thereof, and the like.

Incidentally, during the exposure of the substrate P, there is a possibility that a substance (e.g., an organic substance like a photosensitive material) produced (i.e., eluted) from the substrate P will intermix with the first liquid LQ1 in the immersion space LS as foreign matter (i.e., a contaminant, a particle, or the like). In addition, along with the substance produced by the substrate P, foreign matter suspended in midair and the like might intermix with the first liquid LQ1 of the immersion space LS. As discussed above, during at least part of the exposure sequence, which includes the substrate P exchanging process, the measuring process wherein the measurement stage 3 is used, and the substrate P exposing process, the first liquid LQ1 in the immersion space LS contacts at least part of the liquid immersion member 7.

Accordingly, if foreign matter mixes with the first liquid LQ1 in the immersion space LS, then the foreign matter might adhere to at least some of the lower surface 14 of the liquid immersion member 7. If the foreign matter is left in a state wherein it adheres to the lower surface 14 of the liquid immersion member 7 that contacts the first liquid LQ1, then there is a possibility that such foreign matter will likewise adhere to the substrate P during an exposure or will contaminate the first liquid LQ1 supplied via the first supply ports 21. In addition, if the lower surface 14 of the liquid immersion member 7 becomes contaminated, there is also a possibility that, for example, the immersion space LS will no longer be able to be formed satisfactorily. As a result, exposure failures might occur.

Accordingly, in the present embodiment, the maintenance sequence, which includes cleaning the lower surface 14 of the liquid immersion member 7 that contacts the first liquid LQ1 in the immersion space LS, is performed with a prescribed timing.

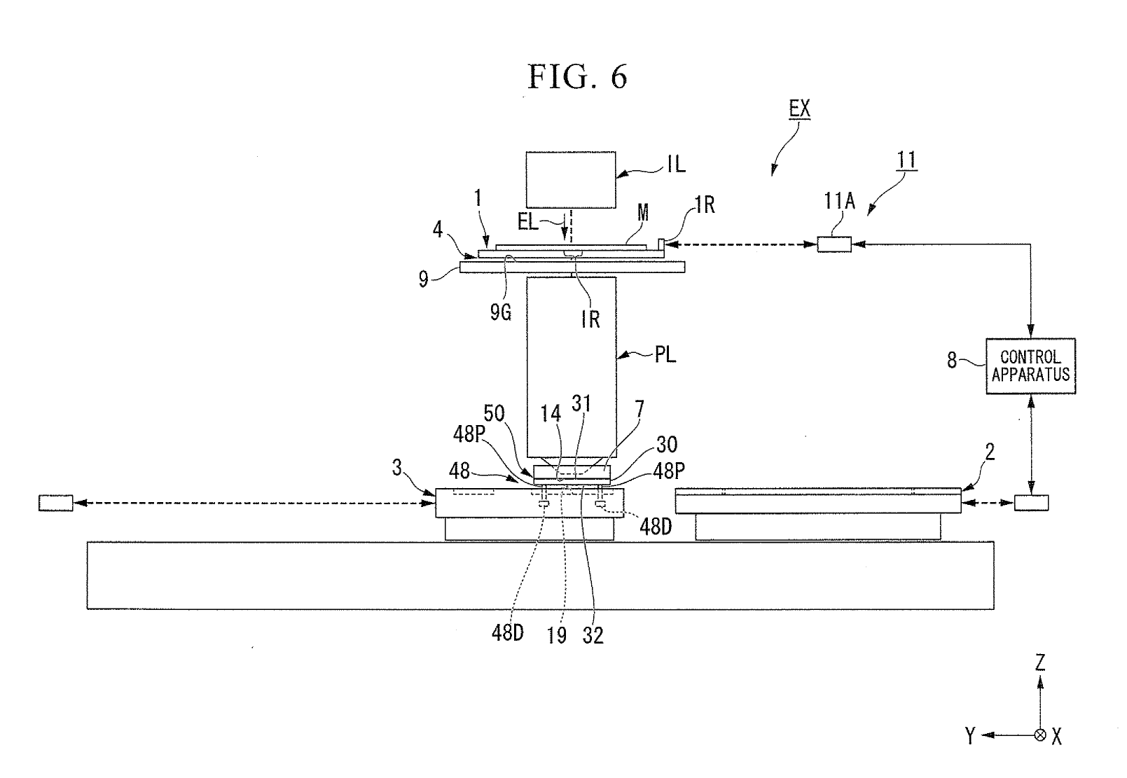

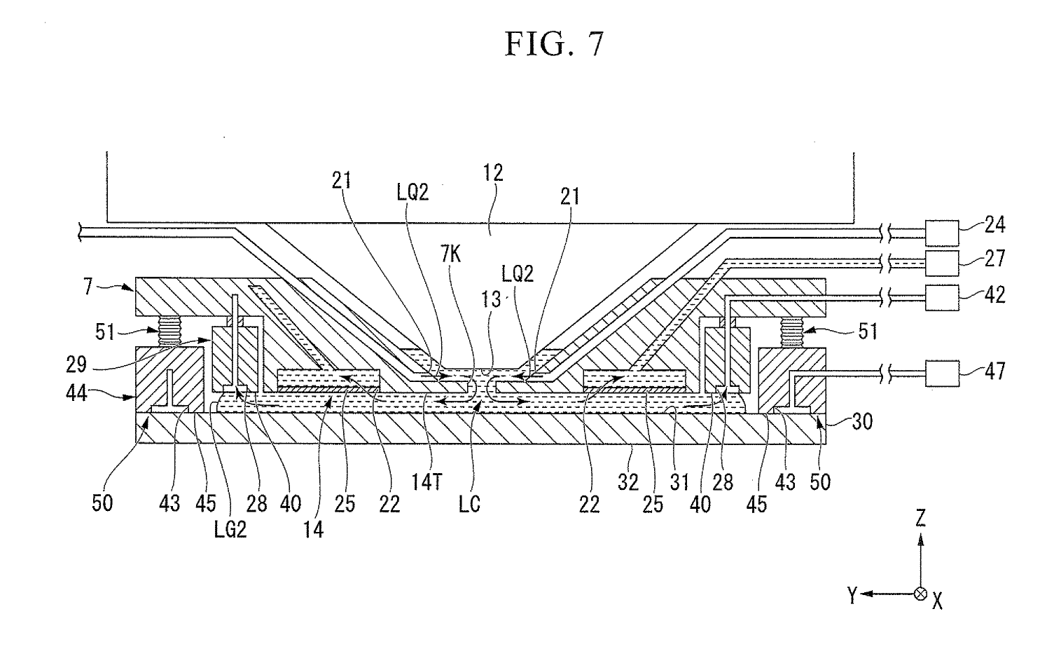

The text below explains one example of the maintenance sequence according to the present embodiment. FIG. 6 and FIG. 7 each show one example of the operation of the exposure apparatus EX during the maintenance sequence according to the present embodiment. In the present embodiment, the maintenance sequence (i.e., the step SB) is performed during the interval in which the exposure sequence (i.e., the step SA) is not performed. In the present embodiment, cleaning is perfouned in the state wherein the upper surface 31 of the cap member 30 is not opposed to the lower surface 14. In addition, in the maintenance sequence, the second liquid LQ2 is held between the emergent surface 13 and the lower surface 14 on one side and the upper surface 31 of the cap member 30 released from the holding part 19 on the other side.

When cleaning of the lower surface 14 is performed, a process is performed, as shown in FIG. 6, wherein the control apparatus 8 releases the cap member 30 from the holding part 19 and transports the released cap member 30 to the holding part 50 (i.e., a step SB1). The control apparatus 8 releases the cap member 30 from the holding part 19 and causes the holding part 50 to hold the released cap member 30. In the present embodiment, the measurement stage 3 comprises a lift mechanism 48, which is capable of moving the cap member 30 released from the holding part 19 in the Z axial directions (i.e., the vertical directions). The lift mechanism 48 comprises a plurality of pin members 48P, which supports the lower surface 32 of the cap member 30 and is capable of moving in the vertical directions, and actuators 48D, which move the pin members 48P. The control apparatus 8 controls the position of the measurement stage 3 wherein the cap member 30 is held by the holding part 19, and, in the state wherein the upper surface 31 of the cap member 30 and the lower surface 14 are opposed, the control apparatus 8 uses the lift mechanism 48 to raise the cap member 30 released from the holding part 19. Thereby, at least part of the upper surface 31 of the cap member 30 and the lower surface 45 of the prescribed member 44 contact one another. In the state wherein the lower surface 45 and at least part of the upper surface 31 are in contact, the control apparatus 8 performs the suction operation via the opening 43. Thereby, the plate member 30 is held by the holding part 50 such that the emergent surface 13 and the lower surface 14 on one side and the upper surface 31 on the other side are opposed. In the maintenance sequence, the substrate stage 2 or the measurement stage 3, or both, is moved (i.e., retracted) to a position other than the position at which the substrate stage 2 or the measurement stage 3, or both, opposes the emergent surface 13 and the lower surface 14.

FIG. 7 shows the state wherein the holding part 50 holds the cap member 30. In the present embodiment, the prescribed member 44 is capable of moving in the Z axial directions by the operation of a drive mechanism 51. In the exposure sequence as shown in FIG. 3, the position of the prescribed member 44 is adjusted such that the lower surface 45 of the prescribed member 44, the lower surface 40 of the recovery member 29, and the lower surface 14 of the liquid immersion member 7 are disposed within substantially the same plane. In the maintenance sequence, as shown in FIG. 7, the control apparatus 8 controls the drive mechanism 51 and adjusts the position of the prescribed member 44 such that the lower surface 45 of the prescribed member 44 is disposed lower than the lower surface 40 of the recovery member 29. Thereby, the upper surface 31 of the cap member 30, which is held by the holding part 50 (i.e., the lower surface 45) and the lower surface 14 of the liquid immersion member 7 are opposed to one another across a prescribed gap. In the maintenance sequence, the holding part 50 holds the cap member 30 such that the emergent surface 13 and the lower surface 14 on one side and the upper surface 31 on the other side are opposed.

The control apparatus 8 starts the cleaning of the lower surface 14 (i.e., the step SB2). In the present embodiment, the cleaning is performed with the second liquid LQ2 held between the upper surface 31 and the lower surface 14.

As shown in FIG. 7, in the present embodiment, the second liquid LQ2 supplied via the first supply ports 21 is held between the emergent surface 13 and the lower surface 14 on one side and the upper surface 31 of the cap member 30, which was released from the holding part 19 and is held by the holding part 50, on the other side. During the cleaning of the lower surface 14, the second liquid LQ2 is supplied via the first supply ports 21; furthermore, the second liquid LQ2 recovery operation via the first recovery port 22 and the second recovery port 28 is performed in parallel with the second liquid LQ2 supply operation via the first supply ports 21. At least some of the second liquid LQ2 supplied via the first supply ports 21 is supplied to the space between the upper surface 31 and the lower surface 14 via the opening 7K. At least some of the second liquid LQ2 between the upper surface 31 and the lower surface 14 is recovered via the first recovery port 22 or the second recovery port 28, or both.

During the maintenance sequence, which includes the cleaning, an immersion space LC, which is formed with the second liquid LQ2 between the upper surface 31 and the lower surface 14, is larger than the immersion, space LS foiined with the first liquid LQ1 between the front surface of the substrate P and the lower surface 14 during the exposure sequence, which includes the substrate P exposure. The size of the immersion space LS is defined as its size within an XY plane that is substantially parallel to the lower surface 14. In the present embodiment, an interface LG2 of the immersion space LC formed with the second liquid LQ2 is formed between the lower surface 40 of the recovery member 29 and the upper surface 31 of the plate member 30. In the present embodiment, substantially the entire area of the lower surface 14 contacts the second liquid LQ2 supplied via the first supply ports 21.

The second liquid LQ2 in the immersion space LC contacts to the lower surface 14 of the liquid immersion member 7, thus the second liquid LQ2 cleans the lower surface 14. In the present embodiment, the lower surface 14 includes the lower surface of the porous member 25, which is also cleaned.

In the present embodiment, the control apparatus 8 makes the quantity of the second liquid LQ2 supplied per unit of time via the first supply ports 21 during the maintenance sequence greater than the quantity of the first liquid LQ1 supplied per unit of time via the first supply ports 21 during the exposure sequence. Thereby, the immersion space LC is filled with the second liquid LQ2, which is supplied via the first supply ports 21 to the space between the liquid immersion member 7 and the recovery member 29 on one side and the cap member 30 on the other side, such that the entire area of the lower surface 14 contacts the second liquid LQ2.

In the present embodiment, because the second liquid LQ2 is supplied via the first supply ports 21 and because at least some of the second liquid LQ2 is recovered via the first recovery port 22 and via the second recovery port 28, which is disposed on the outer side of the lower surface 14 in the radial directions with respect to the optical path K, substantially the entire area of the lower surface 14 of the liquid immersion member 7 can contact the second liquid LQ2 in the immersion space LC. Accordingly, substantially the entire area of the lower surface 14 of the liquid immersion member 7 is cleaned satisfactorily.

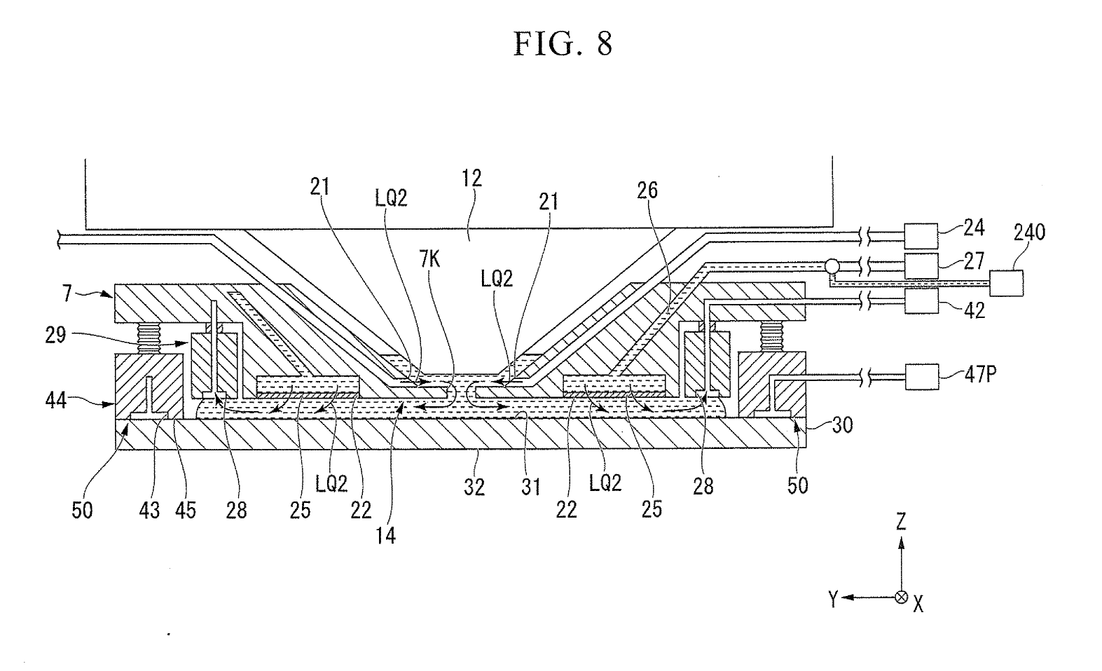

Furthermore, as shown in FIG. 8, during the cleaning of the lower surface 14, the second liquid LQ2 may be supplied via the first supply ports 21 as well as by the first recovery port 22, and the second liquid LQ2 may be recovered via the second recovery port 28. In so doing, substantially the entire area of the lower surface 14 of the liquid immersion member 7 and the second liquid LQ2 can likewise be brought into contact. For example, by connecting a liquid supply apparatus 240, which is capable of supplying the second liquid LQ2 to the passageway 26, and by supplying the second liquid LQ2 from the liquid supply apparatus 240, the second liquid LQ2 can be supplied via the first recovery port 22. Thereby, the passageway 26 that contacts the second liquid LQ2 (i.e., the inner surface of the recovery pipe and the inner surface of the recovery passageway formed inside the liquid immersion member 7), the upper surface of the porous member 25, the inner surfaces of the holes of the porous member 25, and the like are cleaned.

Furthermore, the second liquid LQ2 may be supplied via the first supply ports 21 and at least some of the second liquid LQ2 between the lower surface 14 and the upper surface 31 may be recovered via the second recovery port 28 without supplying and recovering the second liquid LQ2 via the first recovery port 22.

Furthermore, in the present embodiment, the second recovery port 28 is disposed in the recovery member 29, which is different from the liquid immersion member 7; however, the second recovery port 28 may be disposed in the liquid immersion member 7. In other words, the liquid immersion member 7 and the recovery member 29 may be integrated, and a first recovery port and a second recovery port may be provided to that integrated member.

After the cleaning of the lower surface 14 of the liquid immersion member 7 is complete, a process that eliminates the second liquid LQ2 from the lower surface 14 of the liquid immersion member 7 is performed (i.e., a step SB3). To eliminate the second liquid LQ2, the control apparatus 8 supplies the first liquid LQ1 via the first supply ports 21 and the first recovery port 22 after the supply of the second liquid LQ2 has stopped and recovers the first liquid LQ1 or the second liquid LQ2, or both, via the second recovery port 28. For example, by connecting a liquid supply apparatus that is capable of supplying the first liquid LQ1 to the passageway 26 and by supplying the first liquid LQ1 from that liquid supply apparatus, the first liquid LQ1 could be supplied via the first recovery port 22.

The second liquid LQ2 remaining on the lower surface 14 of the liquid immersion member 7 would be eliminated by supplying the first liquid LQ1 via the first supply ports 21, supplying the first liquid LQ1 via the first recovery port 22, and recovering the first liquid LQ1 or the second liquid LQ2, or both, via the second recovery port 28.

In addition, the flow the first liquid LQ1 to the passageway 26 would satisfactorily eliminate the second liquid LQ2 remaining in the passageway 26 (i.e., on the inner surface of the recovery pipe and the inner surface of the recovery passageway formed inside the liquid immersion member 7), on the upper surface of the porous member 25, on the inner surfaces of the holes of the porous member 25, and the like.

After the maintenance sequence is complete, the control apparatus 8 can start (i.e., resume) the exposure sequence.

According to the present embodiment as explained above, the lower surface 14 of the liquid immersion member 7 can be cleaned satisfactorily. Accordingly, it is possible to prevent exposure failures from occurring. In addition, during the cleaning of the liquid immersion member 7, the substrate stage 2 or the measurement stage 3, or both, can be moved to an arbitrary position. Accordingly, the maintenance sequence (i.e., a cleaning process) of the substrate stage 2 or the measurement stage 3, or both, may be performed in parallel with at least part of the maintenance sequence (i.e., the cleaning process) of the liquid immersion member 7 discussed above.

Meanwhile, the maintenance of the substrate stage 2 or the measurement stage 3, or both, is not limited to the cleaning process, but may be the adjusting process and/or the replacing process of parts (components) thereof.

In addition, the maintenance process performed in parallel with at least part of the maintenance sequence (i.e., the cleaning process) of the liquid immersion member 7 is not limited to the maintenance of the substrate stage 2 or the measurement stage 3, or both.

In addition, in the present embodiment, the lower surface 14 and the liquid (i.e., the first liquid LQ1 or the second liquid LQ2, or both) can continue to make contact during the exposure sequence and the maintenance sequence. Thereby, it is possible to prevent the lower surface 14 from becoming contaminated.

### Second Embodiment

The following text explains a second embodiment. In the explanation below, constituent parts that are identical or equivalent to those in the embodiment discussed above are assigned identical symbols, and the explanations thereof are therefore abbreviated or omitted.

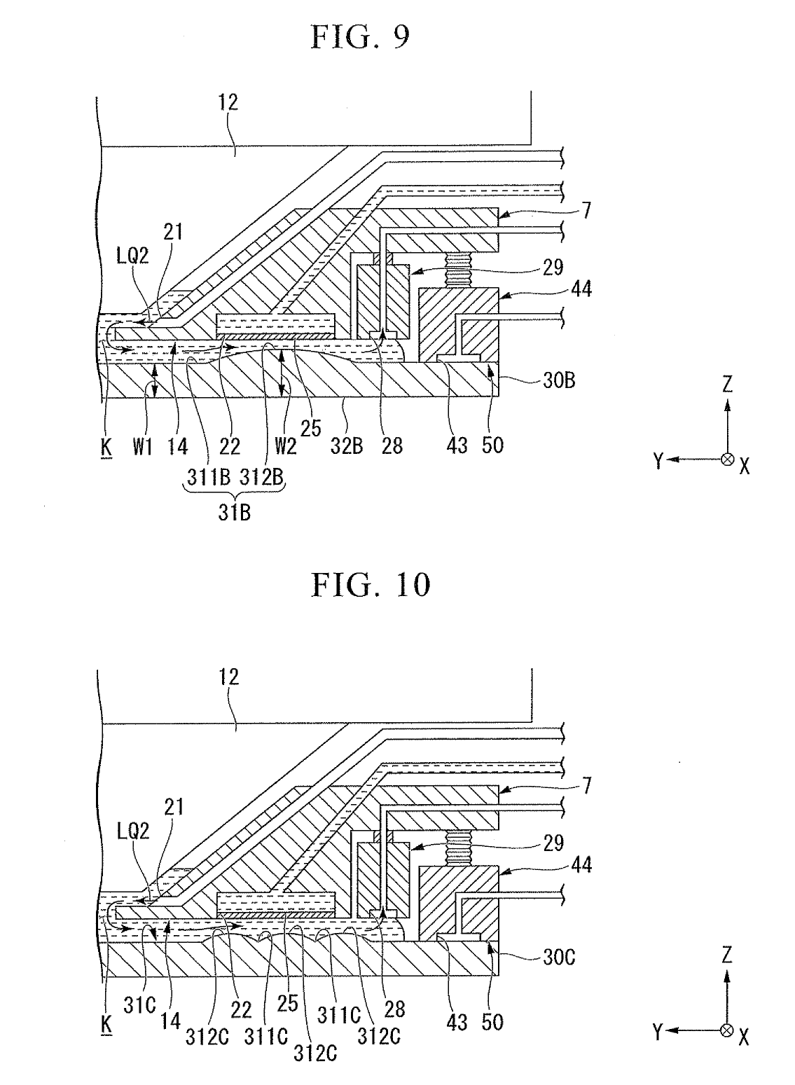

FIG. 9 shows one example of a cap member 3013 according to the second embodiment. As shown in FIG. 9, an upper surface 31B of the cap member 30B may include a first portion 311B and a second portion 312B, which protrudes from the first portion 311B. In FIG. 9, a lower surface 32B is flat. A distance W2 between the second portion 312B of the upper surface 31B and the lower surface 32B is greater than a distance W1 between the first portion 31113 of the upper surface 31B and the lower surface 32B. In the present embodiment, the second portion 312B includes a convex surface, which projects away from the lower surface 3213. The convex surface has a curved shape. In the present embodiment, in the state wherein the cap member 30B is held by the holding part 50, the second portion 312B opposes the lower surface of the porous member 25. At least some of the second liquid LQ2 supplied via the first supply ports 21 flows toward the outer side of the space between the lower surface 14 and the upper surface 31B in the radial directions with respect to the optical path K and is recovered via the second recovery port 28. The gap between the lower surface 14 (i.e., the lower surface of the porous member 25) and the second portion 312B of the upper surface 31B is smaller than the gap between the lower surface 14 and the first portion 311B of the upper surface 31B. Accordingly, the flow velocity of the second liquid LQ2 supplied via the first supply ports 21 and flowing toward the second recovery port 28 is higher in the space between the lower surface 14 and the second portion 312B of the upper surface 31B. In other words, the flow velocity of the second liquid LQ2 flowing such that it contacts the lower surface of the porous member 25 increases locally. Thereby, a strong cleaning effect can be obtained.

Furthermore, a plurality of first portions or a plurality of second portions, or both, may be disposed in the radial directions with respect to the optical path K. For example, as in a cap member 30C shown in FIG. 10, a plurality of first portions 311C and a plurality of second portions 312C of an upper surface 31C may be disposed alternately in the radial directions with respect to the optical path K.

### Third Embodiment

The following text explains a third embodiment. In the explanation below, constituent parts that are identical or equivalent to those in the embodiments discussed above are assigned identical symbols, and the explanations thereof are therefore abbreviated or omitted.

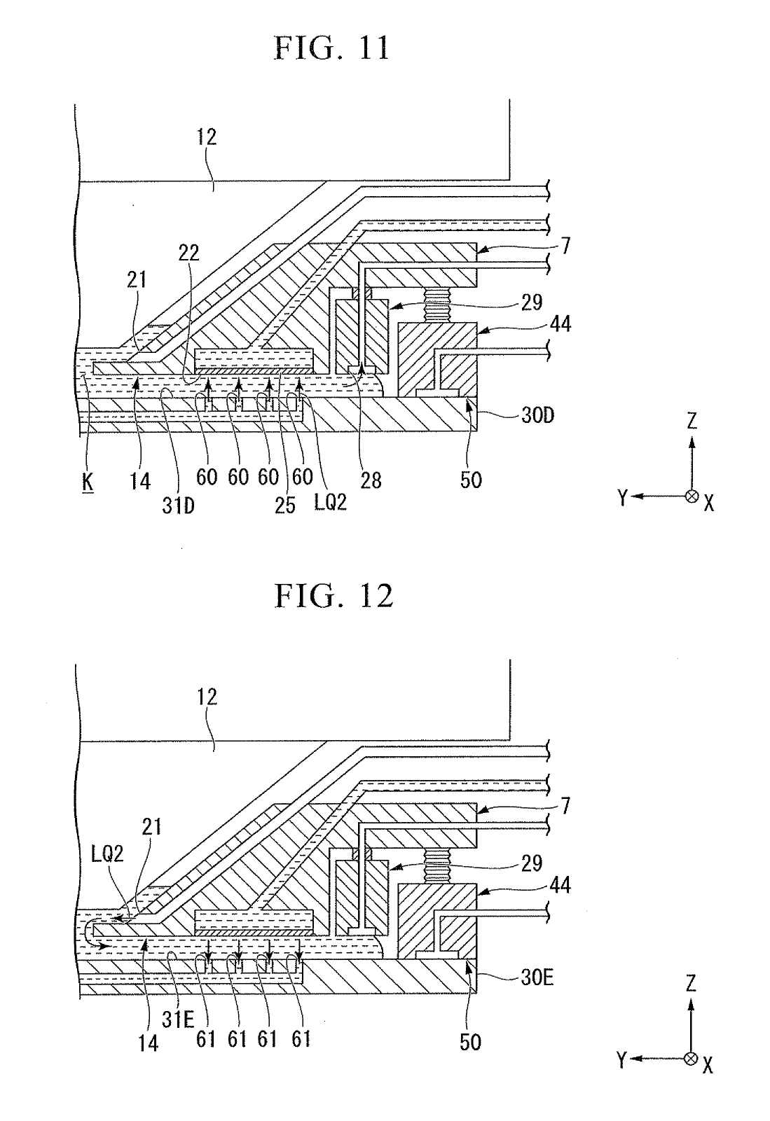

FIG. 11 is a view that shows one example of a cap member 30D according to the third embodiment. In FIG. 11, the cap member 30D is provided with supply ports 60, where through the second liquid LQ2 can be supplied. The supply ports 60 are disposed in at least part of an upper surface 31D of the cap member 30D, which is capable of opposing the lower surface 14. The supply ports 60 are capable of supplying the second liquid LQ2 to a space between the lower surface 14 and the upper surface 31D. In the present embodiment, in the state wherein the cap member 30D is held by the holding part 50, the supply ports 60 oppose the lower surface of the porous member 25. The supply ports 60 jet the second liquid LQ2 toward the lower surface 14.

During the cleaning of the lower surface 14 (i.e., the step SB2), the second liquid LQ2 is supplied via the supply ports 60, which are disposed in the cap member 30D. In the state wherein the cap member 30D is held by the holding part 50, the second liquid LQ2 is supplied via the supply ports 60, which are disposed in the cap member 30D. The supply ports 60 jet the second liquid LQ2 toward the lower surface of the porous member 25. Thereby, the second liquid LQ2 can satisfactorily clean the lower surface 14 (i.e., the lower surface of the porous member 25).

Furthermore, during the cleaning, the operation of supplying the second liquid LQ2 via the supply ports 60, which are disposed in the cap member 30D, may be performed in parallel with the operation of supplying the second liquid LQ2 via the first supply ports 21, which are disposed in the liquid immersion member 7; alternatively, the second liquid LQ2 supply operation via the supply ports 60 may be performed after the second liquid LQ2 supply operation via the first supply ports 21 has been stopped.

In addition, as shown in FIG. 12, a cap member 30E can be provided with recovery ports 61, which are capable of recovering the second liquid LQ2. The recovery ports 61 are disposed in at least part of an upper surface 31E of the cap member 30E, which is capable of opposing the lower surface 14. For example, during cleaning (i.e., the step SB2), at least some of the second liquid LQ2 supplied to the space between the lower surface 14 and the upper surface 31E can be recovered via the recovery ports 61. In addition, during the process that eliminates the second liquid LQ2 (i.e., the step SB3), at least some of the first liquid LQ1 and the second liquid LQ2 supplied to the space between the lower surface 14 and the upper surface 31E can be recovered via the recovery ports 61. Furthermore, both the recovery ports 61 and the supply ports 60 may be provided to the cap member 30E.

### Fourth Embodiment

A fourth embodiment will now be explained. In the explanation below, constituent parts that are identical or equivalent to those in the embodiments discussed above are assigned identical symbols, and the explanations thereof are therefore abbreviated or omitted.

FIG. 13 is a view that shows one example of a cap member 30F according to the fourth embodiment. In FIG. 13, the cap member 30F comprises a brush member 62, which is capable of brushing against at least part of the lower surface 14. The brush member 62 is disposed in at least part of an upper surface 31F of the cap member 30F, which is capable of opposing the lower surface 14. In the state wherein the cap member 30F is held by the holding part 50, the brush member 62 contacts at least part of the lower surface 14. In the present embodiment, the brush member 62 is disposed such that it contacts the porous member 25. By brushing against the lower surface 14 (i.e., the porous member 25), the brush member 62 can clean the lower surface 14 (i.e., the porous member 25). In the present embodiment, the brush member 62 brushes against the lower surface 14 while the second liquid LQ2 recovery operation via the second recovery port 28 is performed in parallel with the operation of supplying the second liquid LQ2 from the first supply ports 21 or the first recovery port 22, or both, to the space between the lower surface 14 and the upper surface 31F. In the present embodiment, too, in the state wherein the upper surface 31F opposes the lower surface 14, the lower surface 14 can be cleaned satisfactorily.

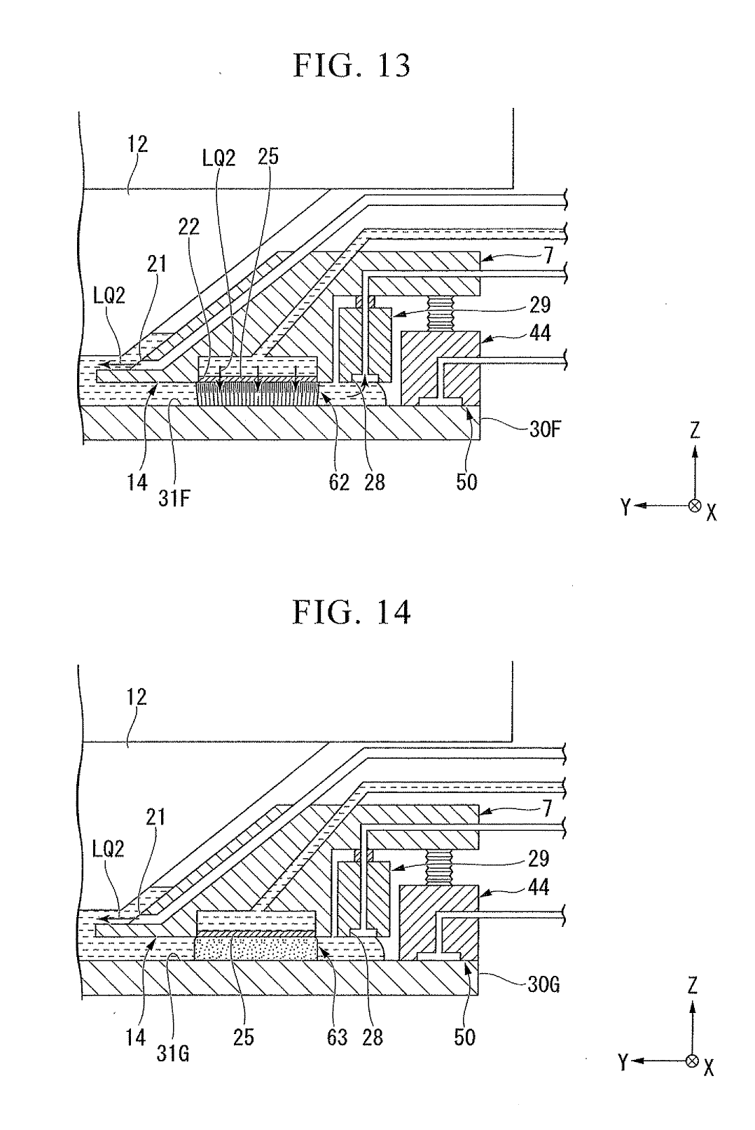

As shown in FIG. 14, a cap member 30G may comprise a porous member 63, which is capable of contacting the lower surface 14. The porous member 63 is, for example, a sponge. The porous member 63 can hold the second liquid LQ2. The porous member 63 is disposed in at least part of an upper surface 31G of the cap member 30G, which is capable of opposing the lower surface 14. In the state wherein the cap member 300 is held by the holding part 50, the porous member 63 contacts at least part of the lower surface 14. In the present embodiment, the porous member 63, which is provided to the cap member 30G, is disposed such that it contacts the porous member 25, which is provided to the liquid immersion member 7. By contacting the lower surface 14, the porous member 63 can clean the lower surface 14.

### Fifth Embodiment

The following text explains a fifth embodiment. In the explanation below, constituent parts that are identical or equivalent to those in the embodiments discussed above are assigned identical symbols, and the explanations thereof are therefore abbreviated or omitted.

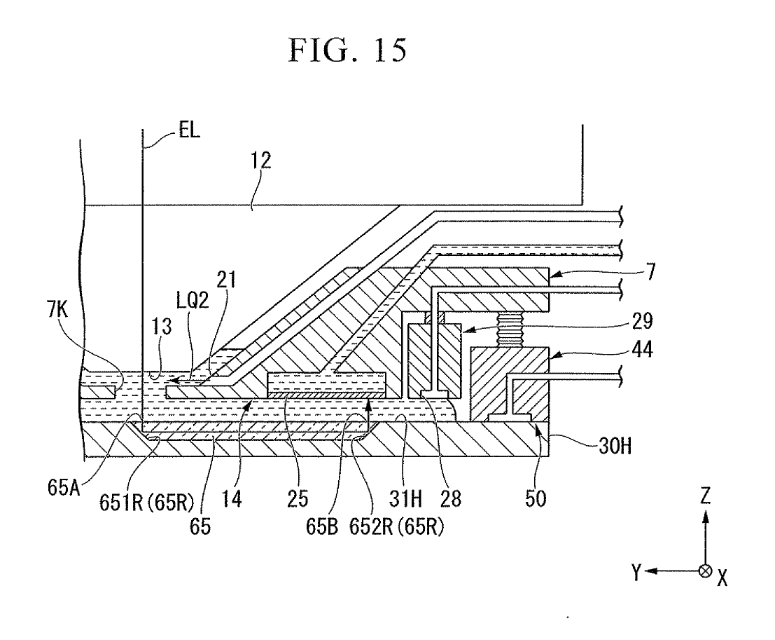

FIG. 15 is a view that shows one example of a cap member 30H according to the fifth embodiment. In FIG. 15, the cap member 30H comprises a reflective part 65R, which reflects the exposure light EL emerging from the emergent surface 13. At least some of the exposure light EL reflected by the reflective part 65R is radiated to the lower surface 14.

In the present embodiment, the cap member 30H holds an optical element 65. The optical element 65 is a prism member. The optical element 65 comprises the reflective part 65R, which reflects the exposure light EL. The reflective part 65R includes a first reflecting surface 651R and a second reflecting surface 652R. The first reflecting surface 651R and the second reflecting surface 652R face different directions. In the state wherein the cap member 30H is held by the holding part 50, at least part of the optical element 65 opposes the emergent surface 13. In addition, in the state wherein the cap member 30H is held by the holding part 50, at least part of the optical element 65 opposes the lower surface 14. The optical element 65 comprises an incident part 65A, onto which the exposure light EL emerging from the emergent surface 13 impinges, and an emergent part 65B, wherefrom the exposure light EL emerges. At least some of the exposure light EL that emerges from the emergent surface 13 and impinges the incident part 65A of the optical element 65 is reflected by the first reflecting surface 651R and the second reflecting surface 652R of the optical element 65 and emerges from the emergent part 65B. The exposure light EL that emerges from the emergent part 65B is radiated to the lower surface 14. Thereby, the lower surface 14 is photo cleaned by the irradiation of the exposure light EL.

In the present embodiment, in the state wherein the lower surface 14 and the second liquid LQ2 contact one another, the exposure light EL emerging from the emergent part 65B is radiated to the lower surface 14. In addition, in the present embodiment, the exposure light EL is radiated to the lower surface 14 while the operation of recovering at least some of the second liquid LQ2 is performed in parallel with the operation of supplying the second liquid LQ2 to the space between the lower surface 14 and an upper surface 31H (including the upper surface of the optical element 65) of the cap member 30H. In the present embodiment as well, the lower surface 14 is cleaned satisfactorily.

### Sixth Embodiment

The following text explains a sixth embodiment. In the explanation below, constituent parts that are identical or equivalent to those in the embodiments discussed above are assigned identical symbols, and the explanations thereof are therefore abbreviated or omitted.

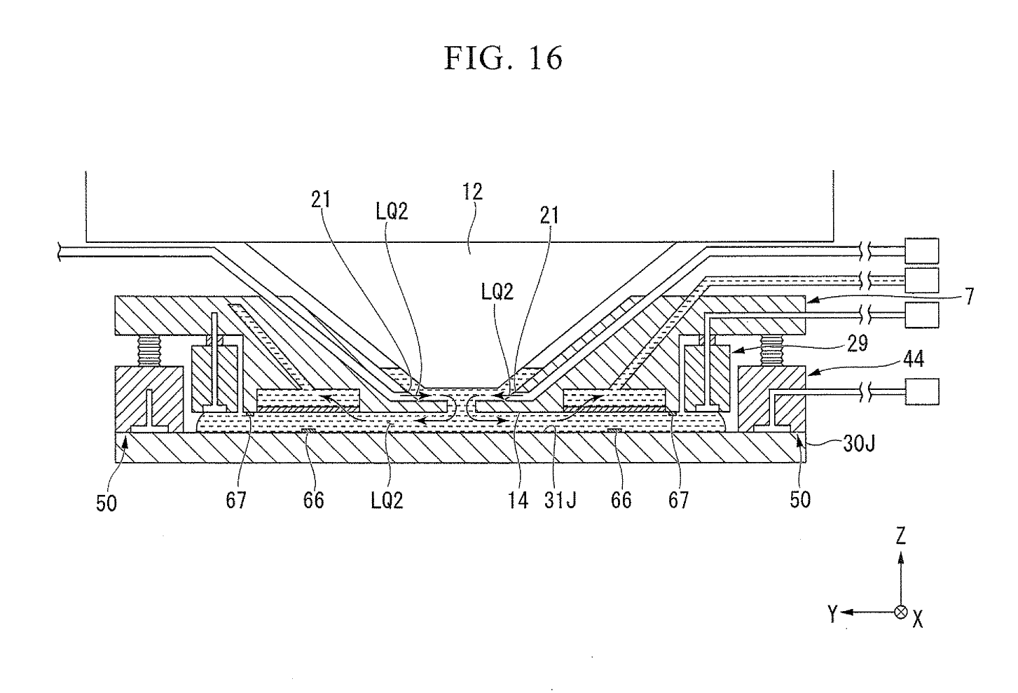

FIG. 16 is a view that shows one example of a cap member 30J according to the sixth embodiment. In FIG. 16, the cap member 30J comprises ultrasonic oscillators 66. The ultrasonic oscillators 66 are, for example, piezoelectric devices. Each of the ultrasonic oscillators 66 can impart ultrasonic vibrations to the second liquid LQ2, which contacts the cap member 30J. In the present embodiment, the ultrasonic oscillators 66 operate in the state wherein the second liquid LQ2 is held between the lower surface 14 and an upper surface 31J of the cap member 30J. The operation of the ultrasonic oscillators 66 imparts ultrasonic vibrations to the second liquid LQ2, which is held between the lower surface 14 and the upper surface 31J such that the second liquid LQ2 contacts the lower surface 14 and the upper surface 31J. Thereby, the effect of cleaning the lower surface 14 can be strengthened.

In addition, ultrasonic oscillators 67, which impart ultrasonic vibrations to the second liquid LQ2 that contacts the liquid immersion member 7, can also be disposed in the liquid immersion member 7. In the state wherein the second liquid LQ2 is held between the lower surface 14 and the upper surface 31J, the operation of the ultrasonic oscillators 67 also can strengthen the effect of cleaning the lower surface 14.

Furthermore, in the first through sixth embodiments discussed above, the substrate stage 2 may also comprise a holding part that releasably holds the cap member (30 and the like).

In addition, in the first through sixth embodiments discussed above, the gas does not have to be supplied from the prescribed member 44. Namely, the prescribed member 44 can be used exclusively for holding the cap member (30 and the like).

### Seventh Embodiment

The following text explains a seventh embodiment. In the explanation below, constituent parts that are identical or equivalent to those in the embodiments discussed above are assigned identical symbols, and the explanations thereof are therefore abbreviated or omitted.

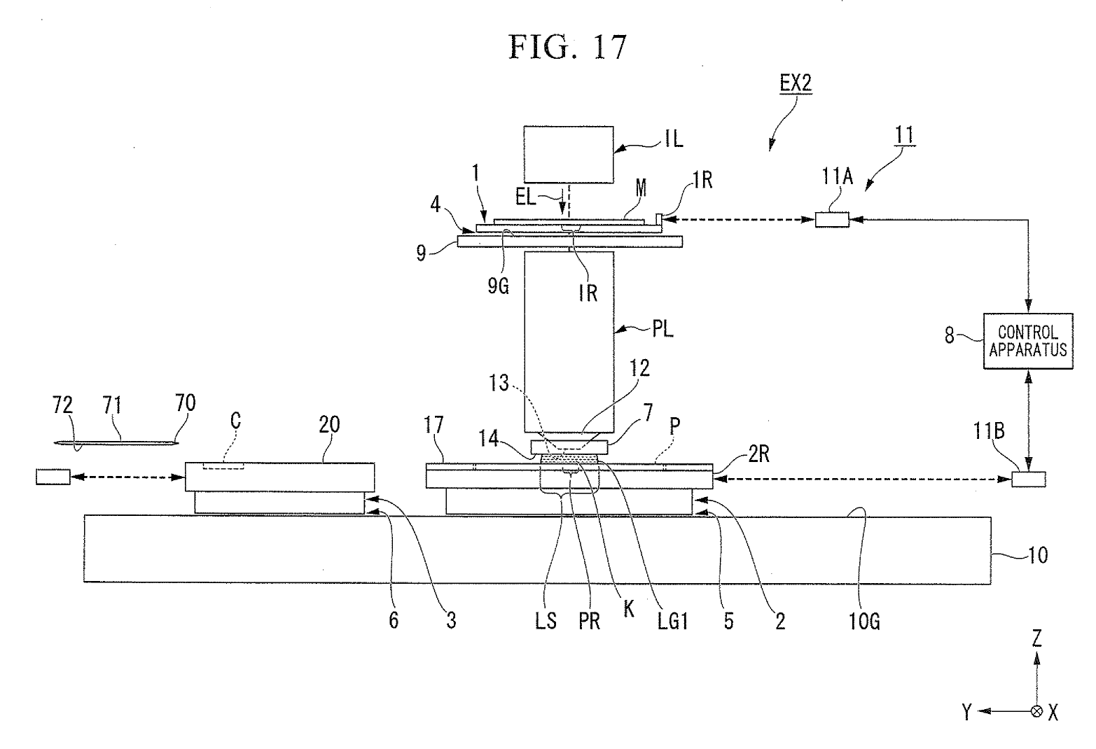

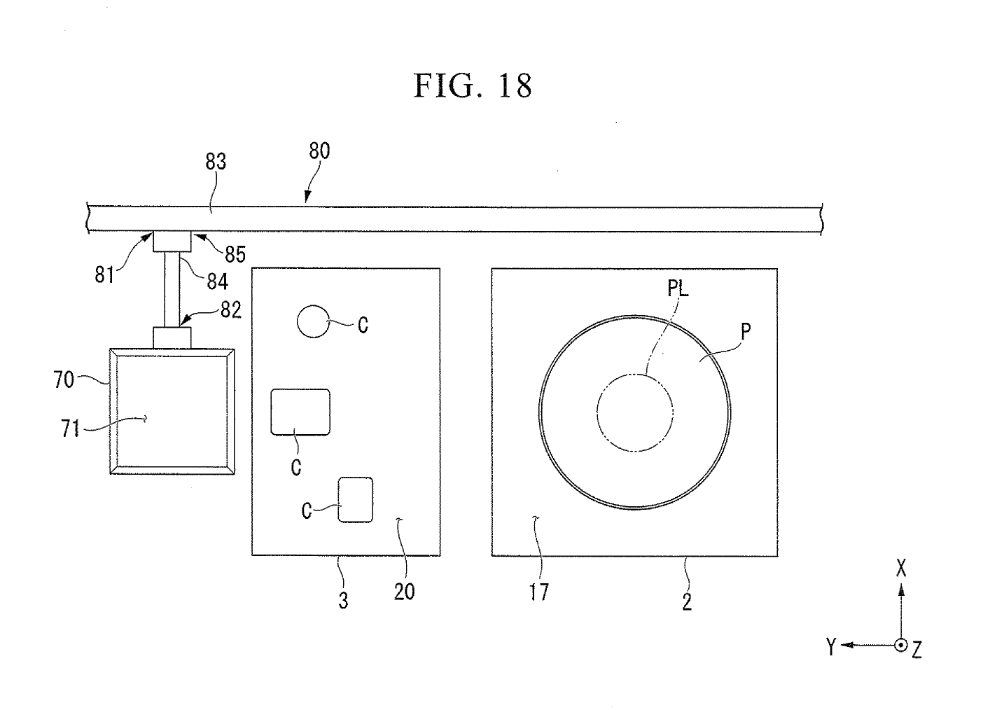

FIG. 17 shows one example of an exposure apparatus EX2 according to the seventh embodiment, and FIG. 18 is a plan view that includes the substrate stage 2 and the measurement stage 3. In the present embodiment, the exposure apparatus EX2 comprises a cover member 70, which is capable of moving to a position at which it opposes the emergent surface 13 and the lower surface 14. The cover member 70 is a plate shaped member that has an upper surface 71 and a lower surface 72. The cover member 70 is capable of moving in a direction substantially parallel to the guide surface 10G (i.e., an XY plane) in the space between the emergent surface 13 and the lower surface 14 on one side and the upper surface 17 or the upper surface 20, or both, on the other side. In addition, the cover member 70 is capable of moving to a position other than the position at which it opposes the emergent surface 13 and the lower surface 14. In the present embodiment, the exposure apparatus EX2 comprises a drive system 80, which moves the cover member 70 in a direction substantially parallel to the guide surface 10G in the space between the emergent surface 13 and the lower surface 14 on one side and the upper surface 17 or the upper surface 20, or both, on the other side.

The upper surface 71 of the cover member 70, together with the emergent surface 13 and the lower surface 14, can form a space that can hold the liquid (i.e., the first liquid LQ1 or the second liquid LQ2, or both). The cover member 70 is capable of opposing the emergent surface 13 and the lower surface 14. The cover member 70 can form the immersion space LS by holding the first liquid LQ1 between itself on one side and the last optical element 12 and the liquid immersion member 7 on the other side. The cover member 70 can move in the X and Y directions between the emergent surface 13 and the lower surface 14 on one side and the upper surface 17 (or the front surface of the substrate P) or the upper surface 20, or both, on the other side. The upper surface 71 of the cover member 70 is capable of opposing the emergent surface 13 and the lower surface 14. The lower surface 72 of the cover member 70 is capable of opposing the upper surface 17 (or the front surface of the substrate P) and the upper surface 20. The angle formed between the circumferential edge area of the upper surface 71 and the circumferential edge area of the lower surface 72 is an acute angle. In other words, the edge of the cover member 70 forms a sharp angle. In addition, the upper surface 71 and the lower surface 72 are each liquid repellent with respect to liquids.

The drive system 80 supports the cover member 70 such that the cover member 70 is capable of moving in the X and Y directions. As shown in FIG. 18, in the present embodiment, the drive system 80 comprises a first drive apparatus 81, which is capable of moving the cover member 70 in the Y axial directions with a prescribed stroke, and a second drive apparatus 82, which is capable of moving the cover member 70 in the X axial, Y axial, and θZ directions. The first drive apparatus 81 comprises a guide member 83, which is long in the Y axial directions, and a linear motor 85 that moves a support mechanism 84, which supports the cover member 70, in the Y axial directions along the guide member 83. The linear motor 85 comprises: a stator, which is disposed in the guide member 83 and comprises, for example, a coil; and a slider, which is disposed in the support mechanism 84 and comprises, for example, a magnet. The second drive apparatus 82 is, for example, a linear motor or a voice coil motor, which is disposed in the support mechanism 84 and is capable of moving the cover member 70 in the X axial, Y axial, and θZ directions.

The drive system 80 is provided separately from the substrate stage 2 and the measurement stage 3. In addition, the drive systems 5, 6 and the drive system 80 are separately provided. The control apparatus 8 is capable of controlling the drive system 80 independently of the drive systems 5, 6.

In the present embodiment, when the substrate stage 2 and the measurement stage 3 are disposed at a position at which they do not oppose the emergent surface 13 and the lower surface 14, the cover member 70 is disposed at a position at which it does oppose the emergent surface 13 and the lower surface 14. For example, when the substrate stage 2 is moved to the substrate exchange position CP, the cover member 70 is disposed at a position at which it opposes the emergent surface 13 and the lower surface 14, and the immersion space LS is formed by holding the first liquid LQ1 between the cover member 70 on one side and the emergent surface 13 and the lower surface 14 on the other side.

In addition, when the substrate stage 2 or the measurement stage 3, or both, is disposed at a position at which the substrate stage 2 or the measurement stage 3, or both, opposes the emergent surface 13 and the lower surface 14, the cover member 70 is capable of moving to a position at which it does not oppose the emergent surface 13 and the lower surface 14. For example, when the control apparatus 8 exposes the substrate P held by the substrate stage 2, it does so in the state wherein the cover member 70 is disposed at a position at which the cover member 70 does not oppose the emergent surface 13 and the lower surface 14.

For example, as shown in FIG. 3, in the present embodiment, the upper surface 17 of the substrate stage 2 (or the front surface of the substrate P or the upper surface 20 of the measurement stage 3) opposes the lower surface 14 across a first gap and is capable of holding the first liquid LQ1 between itself and the lower surface 14. When the first liquid LQ1 is held between the cover member 70 and the lower surface 14, the distance between the upper surface 71 of the cover member 70 and the lower surface 14 is smaller than the first gap. The upper surface 71 of the cover member 70, by virtue of its ability to form a space between itself on one side and the emergent surface 13 and the lower surface 14 on the other side that holds the first liquid LQ1, is capable of forming the immersion space LS. In the present embodiment, the control apparatus 8 disposes the cover member 70, the substrate stage 2, the measurement stage 3, or any combination thereof at a position at which such opposes the emergent surface 13 and the lower surface 14 and continues to form the space—between the emergent surface 13 and the lower surface 14 on one side and the upper surface 71 of the cover member 70, the upper surface 17 of the substrate stage 2, the upper surface 20 of the measurement stage 3, or any combination thereof on the other side—that holds the first liquid LQ1. Namely, the control apparatus 8 can continue to form the immersion space LS by disposing the cover member 70, the substrate stage 2, the measurement stage 3, or any combination thereof at a position at which such opposes the emergent surface 13 and the lower surface 14.

In addition, the control apparatus 8 can form the immersion space LC by holding the second liquid LQ2 between the upper surface 71 of the cover member 70 on one side and the lower surface 14 and the emergent surface 13 on the other side.

By controlling the drive system 5 and the drive system 80 and moving the cover member 70 and the substrate stage 2 relative to one another in the X and Y directions, the control apparatus 8 can switch the holding of the liquid (i.e., the first liquid LQ1 or the second liquid LQ2, or both) from between the last optical element 12 and the liquid immersion member 7 on one side and the cover member 70 on the other side to between the last optical element 12 and the liquid immersion member 7 on one side and the substrate stage 2 on the other side, and vice versa. Likewise, by controlling the drive system 6 and the drive system 80 and moving the cover member 70 and the measurement stage 3 relative to one another in the X and Y directions, the control apparatus 8 can switch the holding of the liquid (i.e., the first liquid LQ1 or the second liquid LQ2, or both) from between the last optical element 12 and the liquid immersion member 7 on one side and the cover member 70 on the other side to between the last optical element 12 and the liquid immersion member 7 on one side and the measurement stage 3 on the other side, and vice versa. Thereby, even if the substrate stage 2 and the measurement stage 3 are moved to a position at which they do not oppose the emergent surface 13 and the lower surface 14, the immersion space LS (or the immersion space LC) can continue to be formed.

In addition, in the present embodiment, the control apparatus 8 can control the drive system 80 so as to insert the cover member 70 between the emergent surface 13 and the lower surface 14 on one side and the upper surface 17 of the substrate stage 2 (or the upper surface 20 of the measurement stage 3), which is disposed at a position at which it opposes the emergent surface 13 and the lower surface 14, on the other side. In addition, the control apparatus 8 can control the drive system 80 so as to withdraw the cover member 70 from the space between the emergent surface 13 and the lower surface 14 on one side and the upper surface 17 of the substrate stage 2 (or the upper surface 20 of the measurement stage 3), which is disposed at a position at which it opposes the emergent surface 13 and the lower surface 14, on the other side. To switch the holding of the liquid from between the emergent surface 13 and the lower surface 14 on one side and the cover member 70 on the other side to between the emergent surface 13 and the lower surface 14 on one side and the substrate stage 2 (the measurement stage 3) on the other side, and vice versa, the control apparatus S can perform either the operation of inserting or the operation of withdrawing the cover member 70.

In addition, in the present embodiment, the control apparatus 8 performs cleaning of the lower surface 14 in the state wherein the upper surface 71 of the cover member 70 opposes the emergent surface 13 and the lower surface 14.

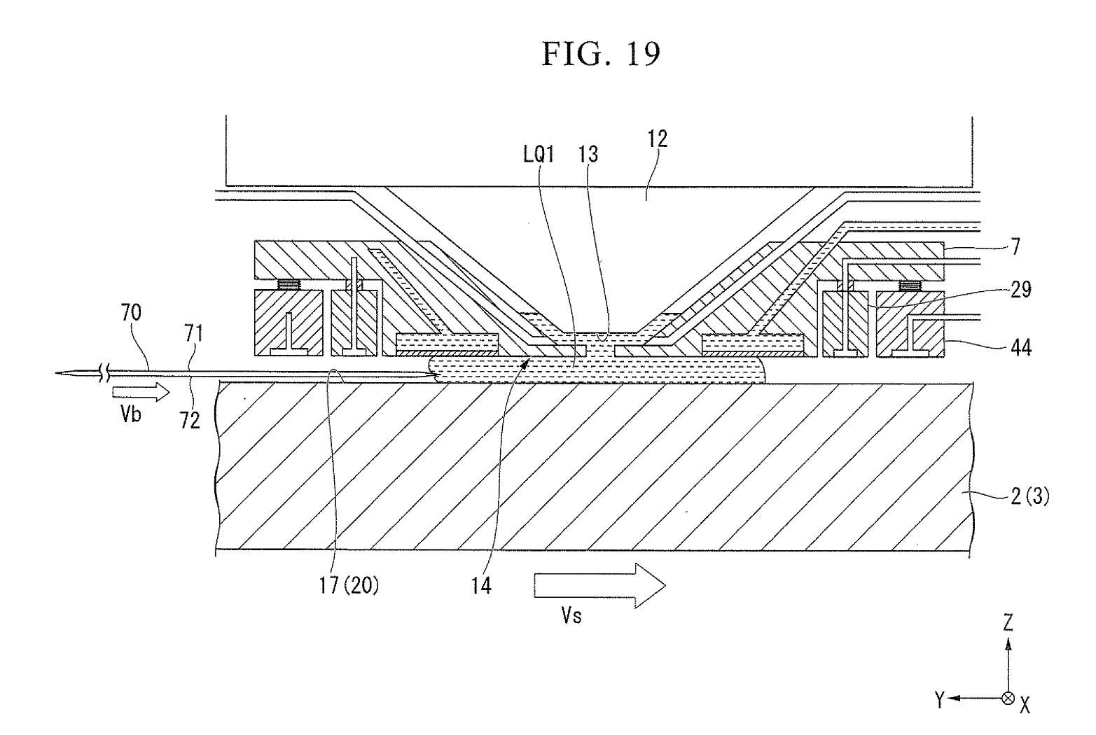

The following text references the schematic drawings in FIG. 19 through FIG. 22 and explains one example of an operation wherein, after the exposure of the substrate P held by the substrate stage 2, the holding of the first liquid LQ1 is switched from between the last optical element 12 and the liquid immersion member 7 on one side and the substrate stage 2 on the other side to between the last optical element 12 and the liquid immersion member 7 on one side and the cover member 70 on the other side. Furthermore, although the following text explains the operation wherein the holding of the first liquid LQ1 is switched from between the last optical element 12 and the liquid immersion member 7 on one side and the substrate stage 2 on the other side to between the last optical element 12 and the liquid immersion member 7 on one side and the cover member 70 on the other side, the same applies to the operation of switching from the measurement stage 3 to the cover member 70.

In the present embodiment, the control apparatus 8 moves the cover member 70 and the substrate stage 2 in substantially the same direction during the switching. The present embodiment explains an exemplary case wherein the cover member 70 and the substrate stage 2 are each moved in the −Y direction.

In addition, in the present embodiment, the control apparatus 8 moves the cover member 70 and the substrate stage 2 independently at different velocities during switching. The control apparatus 8 moves the cover member 70 in the −Y direction at a velocity Vb and moves the substrate stage 2 in the −Y direction at a velocity Vs. In the present embodiment, when the holding of the first liquid LQ1 is switched from between the last optical element 12 and the liquid immersion member 7 on one side and the substrate stage 2 on the other side to between the last optical element 12 and the liquid immersion member 7 on one side and the cover member 70 on the other side, the substrate stage 2 is moved at a higher velocity than the cover member 70 is.

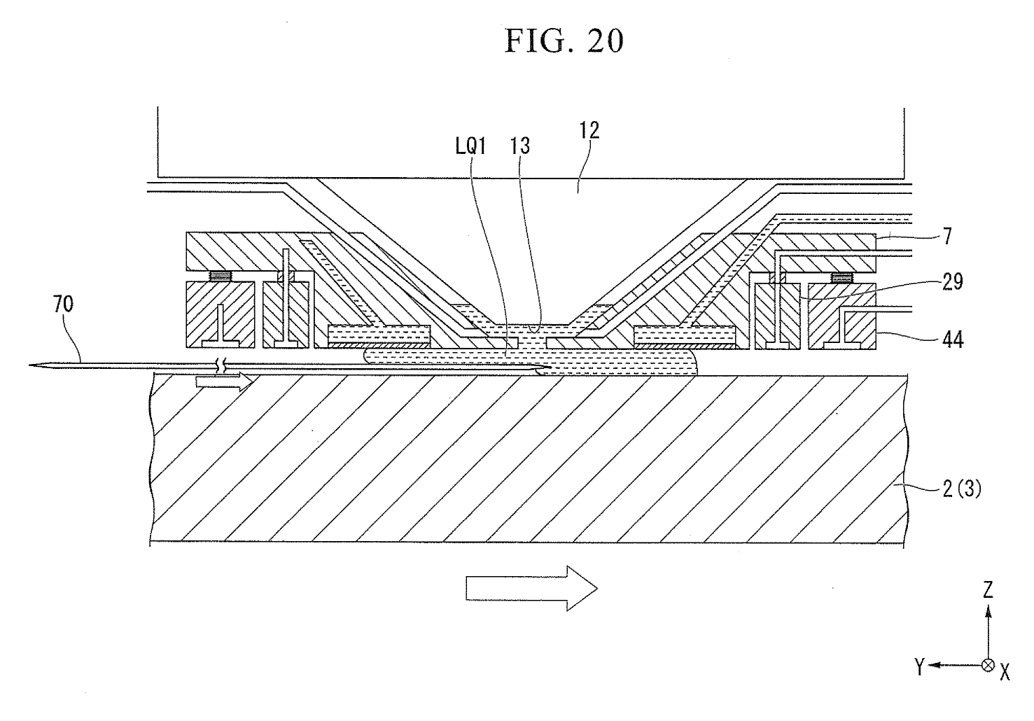

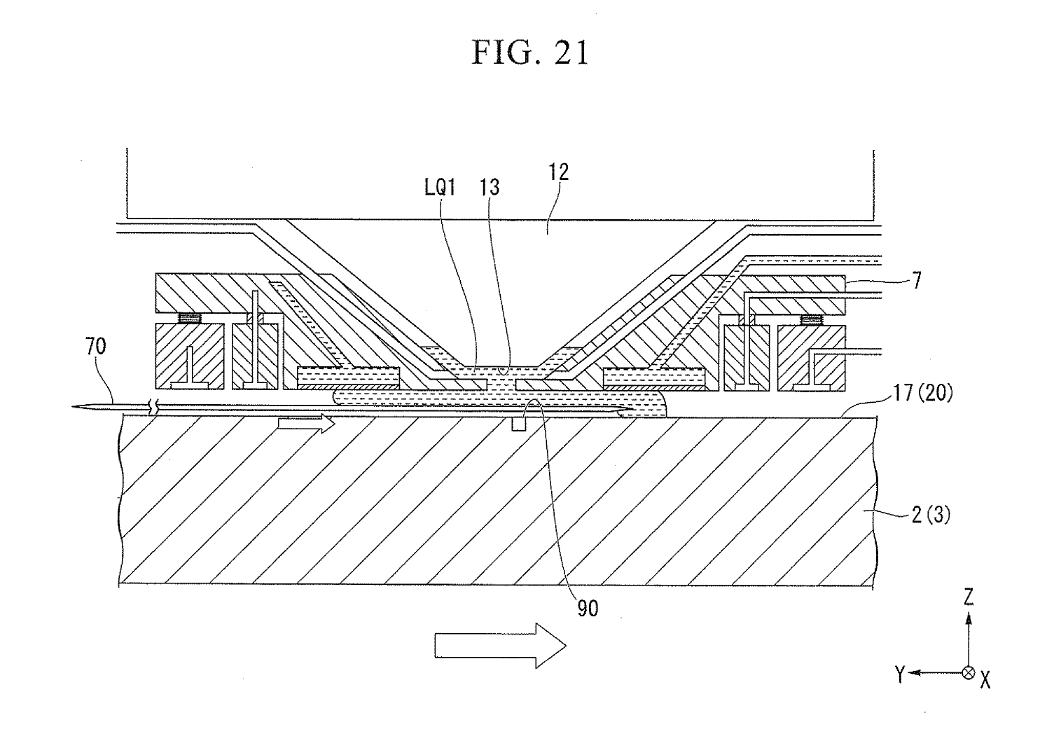

As shown in FIG. 19, in the state wherein the first liquid LQ1 is held between the last optical element 12 and the liquid immersion member 7 on one side and the substrate stage 2 on the other side, the control apparatus 8 inserts the cover member 70, which is disposed at a position at which it does not oppose the emergent surface 13 and the lower surface 14, between the last optical element 12 and the liquid immersion member 7 on one side and the substrate stage 2 on the other side such that the cover member 70 moves to a position at which it does oppose the emergent surface 13 and the lower surface 14. The control apparatus 8 moves the cover member 70 in the −Y direction—synchronized to the movement of the substrate stage 2 in the −Y direction—so as to insert the cover member 70 into the space between the last optical element 12 and the liquid immersion member 7 on one side and the substrate stage 2 on the other side. During the insertion of the cover member 70, the control apparatus 8 moves the cover member 70 at the velocity Vb, which is lower than the velocity Vs of the substrate stage 2. By moving the substrate stage 2 in the −Y direction and the cover member 70 in the −Y direction, the first liquid LQ1 transitions from the state shown in FIG. 19 through the state shown in FIG. 20 and onto the state shown in FIG. 21.

As shown in FIG. 19 through FIG. 21, the control apparatus 8 inserts the cover member 70 such that the last optical element 12, the liquid immersion member 7, and the substrate stage 2 do not contact the cover member 70. Namely, the cover member 70 moves spaced apart from the last optical element 12, the liquid immersion member 7, and the substrate stage 2.

After the cover member 70 is disposed at a position at which it opposes the emergent surface 13 and the lower surface 14 and the operation of inserting the cover member 70 is complete, the immersion space LS is formed by holding the first liquid LQ1 between the last optical element 12 and the liquid immersion member 7 on one side and the cover member 70, which is disposed at a position at which it opposes the emergent surface 13 and the lower surface 14, on the other side. In addition, in the state after the operation of inserting the cover member 70 is complete, the first liquid LQ1 is eliminated from the space between the cover member 70 and the substrate stage 1

As shown in FIG. 21, in the present embodiment, the substrate stage 2 has a recovery port 90, wherethrough the first liquid LQ1 is recovered. The recovery port 90 is capable of recovering the first liquid LQ1 or the second liquid LQ2, or both. The recovery port 90 is provided to the upper surface 17 of the substrate stage 2. Thereby, during the insertion operation, even if the first liquid LQ1 remains in the space between the cover member 70 and the substrate stage 2, that remaining first liquid LQ1 can be recovered via the recovery port 90.

After the first liquid LQ1 is held between the last optical element 12 and the liquid immersion member 7 on one side and the cover member 70 on the other side, the substrate stage 2 (or the measurement stage 3) is moved to a position at which it is spaced apart from the last optical element 12 and the liquid immersion member 7.

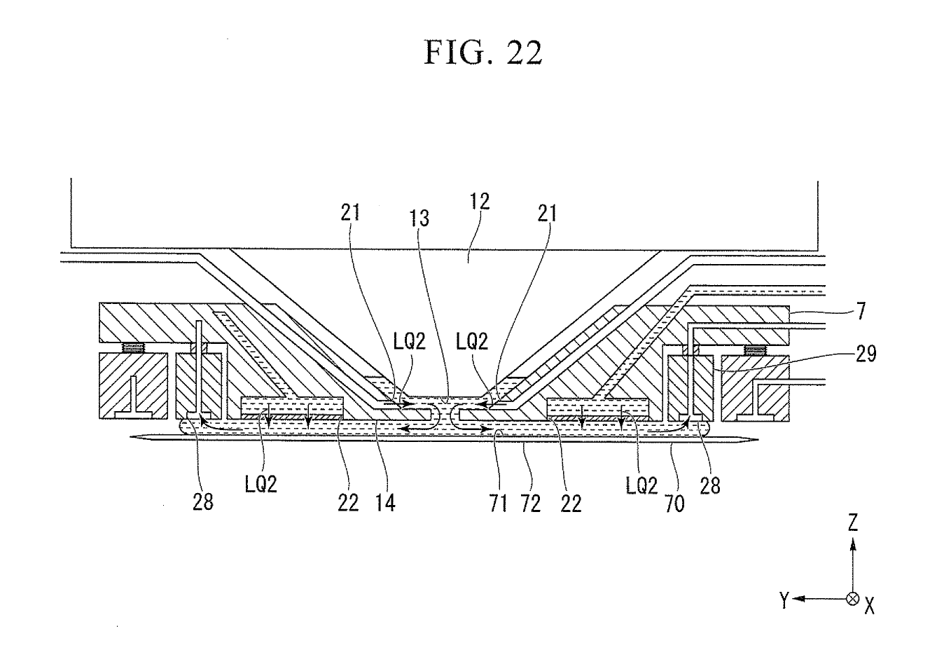

In the state wherein the upper surface 71 of the cover member 70 opposes the emergent surface 13 and the lower surface 14, the control apparatus 8 starts the cleaning. As shown in FIG. 22, the control apparatus 8 cleans the lower surface 14 of the liquid immersion member 7 by performing the second liquid LQ2 supply operation via the first supply ports 21, the second liquid LQ2 supply operation via the first recovery port 22, and the liquid recovery operation via the second recovery port 28.

After the cleaning using the second liquid LQ2 is complete, the control apparatus 8 eliminates the second liquid LQ2 remaining in the liquid immersion member 7 and the like by performing, in the state wherein the upper surface 71 of the cover member 70 opposes the emergent surface 13 and the lower surface 14, the first liquid LQ1 supply operation via the first supply ports 21, the liquid recovery operation via the first recovery port 22, and the liquid recovery operation via the second recovery port 28. After the elimination of the second liquid LQ2 remaining in the liquid immersion member 7 and the like is complete, the control apparatus 8 forms the immersion space LS of the first liquid LQ1 between the emergent surface 13 and the lower surface 14 on one side and the upper surface 71 on the other side by performing the first liquid LQ1 recovery operation via the first recovery port 22 in parallel with the first liquid LQ1 supply operation via the first supply ports 21. Furthermore, to eliminate the second liquid LQ2, the first liquid LQ1 may be supplied via the first recovery port22.

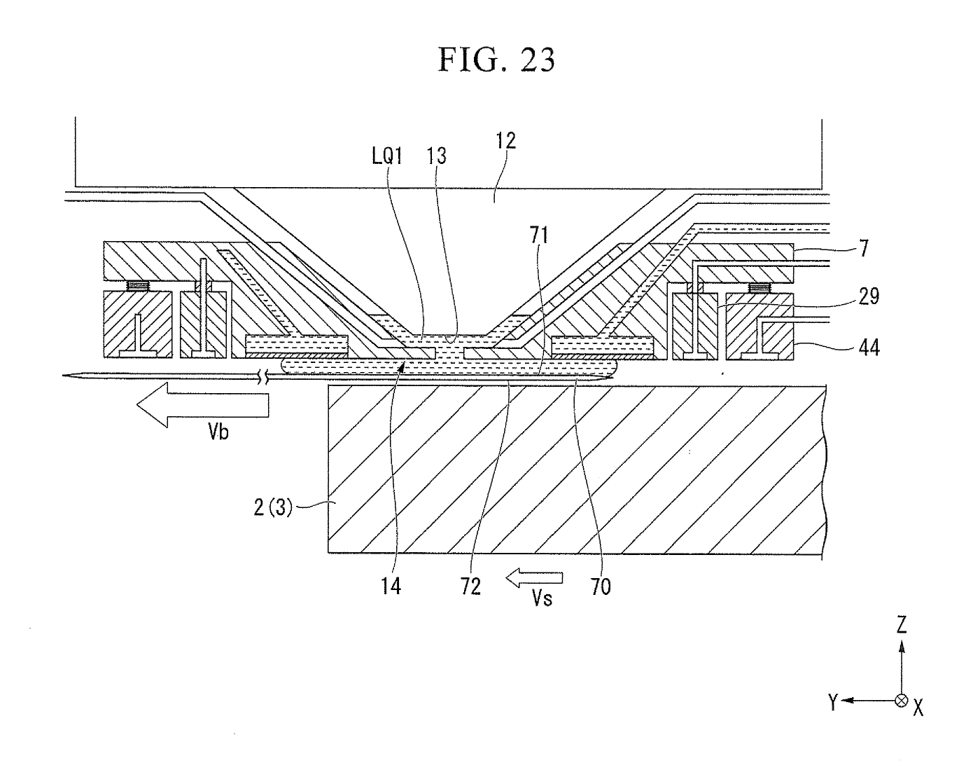

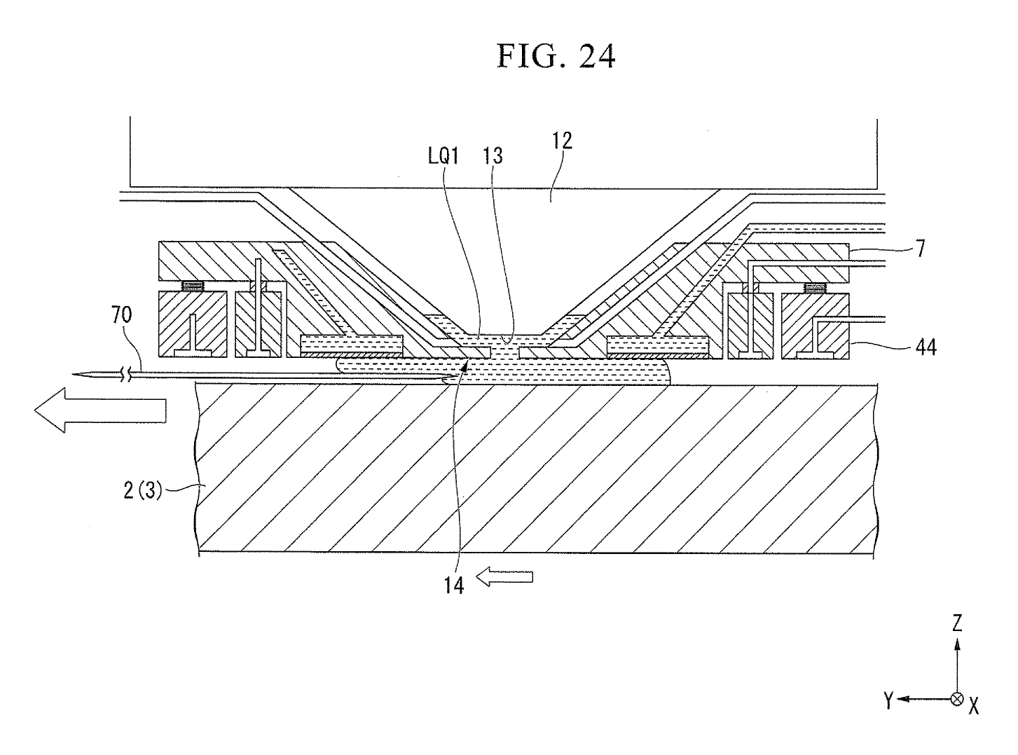

The control apparatus 8 performs the operation of switching the holding of the first liquid LQ1 from between the last optical element 12 and the liquid immersion member 7 on one side and the cover member 70 on the other side to between the last optical element 12 and the liquid immersion member 7 on one side and the substrate stage 2 (or the measurement stage 3) on the other side. The text below explains an exemplary case of the operation of switching the holding of the first liquid LQ1 from between the last optical element 12 and the liquid immersion member 7 on one side and the cover member 70 on the other side to between the last optical element 12 and the liquid immersion member 7 on one side and the substrate stage 2 on the other side, referencing the schematic drawings in FIG. 23 through FIG. 24. Furthermore, the text below explains an exemplary case of the operation of switching the holding of the first liquid LQ1 from between the last optical element 12 and the liquid immersion member 7 on one side and the cover member 70 on the other side to between the last optical element 12 and the liquid immersion member 7 on one side and the substrate stage 2 on the other side, but the same applies to the operation of switching from the cover member 70 to the measurement stage 3.

In the present embodiment, the control apparatus 8 moves the cover member 70 and the substrate stage 2 in substantially the same direction during the switching. The present embodiment explains an exemplary case wherein the cover member 70 and the substrate stage 2 are each moved in the +Y direction.

In addition, in the present embodiment, the control apparatus 8 moves the cover member 70 and the substrate stage 2 independently at different velocities during switching. The control apparatus 8 moves the cover member 70 in the +Y direction at a velocity Vb and moves the substrate stage 2 in the +Y direction at a velocity Vs. In the present embodiment, when the holding of the first liquid LQ1 is switched from between the last optical element 12 and the liquid immersion member 7 on one side and the cover member 70 on the other side to between the last optical element 12 and the liquid immersion member 7 on one side and the substrate stage 2 on the other side, the cover member 70 is moved at a higher velocity than the substrate stage 2 is.

As shown in FIG. 23, in the state wherein the first liquid LQ1 is held between the last optical element 12 and the liquid immersion member 7 on one side and the cover member 70 on the other side, the control apparatus 8 moves the substrate stage 2 to a position at which it opposes the emergent surface 13 and the lower surface 14 with the cover member 70 interposed therebetween. Namely, the control apparatus 8 moves the substrate stage 2 to a position at which the substrate stage 2 opposes at least part of the lower surface 72 of the cover member 70, the cover member 70 holding the first liquid LQ1 between itself on one side and the last optical element 12 and the liquid immersion member 7 on the other side. Thereby, the cover member 70 transitions to the state wherein it is disposed between the last optical element 12 and the liquid immersion member 7 on one side and the substrate stage 2 on the other side.

The control apparatus 8 withdraws the cover member 70, which is disposed at a position at which it opposes the emergent surface 13 and the lower surface 14, from the space between the last optical element 12 and the liquid immersion member 7 on one side and the substrate stage 2 on the other side such that the cover member 70 moves to a position at which it does not oppose the emergent surface 13 and the lower surface 14. In the present embodiment, the control apparatus 8 withdraws the cover member 70 from the space between the last optical element 12 and the liquid immersion member 7 on one side and the substrate stage 2 on the other side by moving the cover member 70 in the +Y direction synchronized to the movement of the substrate stage 2 in the +Y direction. The control apparatus 8 withdraws the cover member 70 in the state wherein the first liquid LQ1 is held between the last optical element 12 and the liquid immersion member 7 on one side and the cover member 70 on the other side.

During the withdrawal of the cover member 70, the control apparatus 8 moves the cover member 70 at the velocity Vb, which is higher than the velocity Vs of the substrate stage 2. By moving both the substrate stage 2 and the cover member 70 in the +Y direction, the first liquid LQ1 transitions from the state shown in FIG. 23 to the state shown in FIG. 24.

After the cover member 70 moves to a position at which it does not oppose the emergent surface 13 and the lower surface 14 and the operation of withdrawing the cover member 70 is complete, the immersion space LS is formed by holding the first liquid LQ1 between the last optical element 12 and the liquid immersion member 7 on one side and the substrate stage 2, which is disposed at a position at which it opposes the emergent surface 13 and the lower surface 14, on the other side. Thereby, the configuration transitions to a state wherein it is possible to perform an immersion exposure on the substrate P.

In the present embodiment, too, the lower surface 14 can be cleaned satisfactorily. In addition, in the present embodiment, too, the lower surface 14 and the liquid (i.e., the first liquid LQ1 or the second liquid LQ2, or both) can continue to be made to contact one another.

Furthermore, the various elements explained in the second through seventh embodiments discussed above can be adapted to the cover member 70. For example, the upper surface 71 of the cover member 70 may have a first portion and a second portion that protrudes from the first portion. In addition, the cover member 70 may have a supply port that is capable of supplying the second liquid LQ, a recovery port, a brush member, a porous member, an optical element that has a reflective part, an ultrasonic oscillator, or any combination thereof.

Furthermore, in the first through seventh embodiments discussed above, the first liquid LQ1 for exposure and the second liquid LQ2 for cleaning are different liquids, but they may be the same liquid. In such a case, the process of eliminating the second liquid LQ2 can be omitted.

Meanwhile, if the first liquid LQ1 is used for the cleaning process, then, in the state where the cap member (i.e. 30) is held by the holding part 50, an operation of recovering the first liquid LQ1 via the first recovery port 22 may be only performed in parallel with an operation of supplying the first liquid LQ1 via the first supply port 21.

Furthermore, in the exposure sequence of the first through seventh embodiments discussed above, the suction operation via the second recovery port 28 does not have to be performed. Namely, the second recovery port 28 may be used exclusively in the maintenance sequence.

In addition, in the maintenance sequence of the first through seventh embodiments discussed above, the second liquid LQ2 may be supplied via the first supply ports 21 and be recovered only via the first recovery port 22. If the recovery member 29 is not used in the recovery of the second liquid LQ2, then the recovery member 29 may be omitted.

In addition, because the second liquid LQ2 contacts the last optical element 12 in the maintenance sequence of the first through seventh embodiments discussed above, it can expected that the last optical element 12 will be cleaned by the second liquid LQ2; however, the second liquid LQ2 does not have to contact the last optical element 12.

In addition, the maintenance sequence (i.e., the cleaning process) may be performed: before the start of the exposing process for one lot of the substrates P, which comprises a prescribed number of the substrates P; after the completion of the exposing process of the one lot of the substrates P; every time a prescribed interval elapses; every prescribed number of substrate processings ; during idling (i.e., when the exposure apparatus EX is not in use); if the number of defects in the pattern formed on the substrate P by the exposing process increases; if the quality of the first liquid LQ1 recovered via the first recovery port 22 deteriorates; or the like.

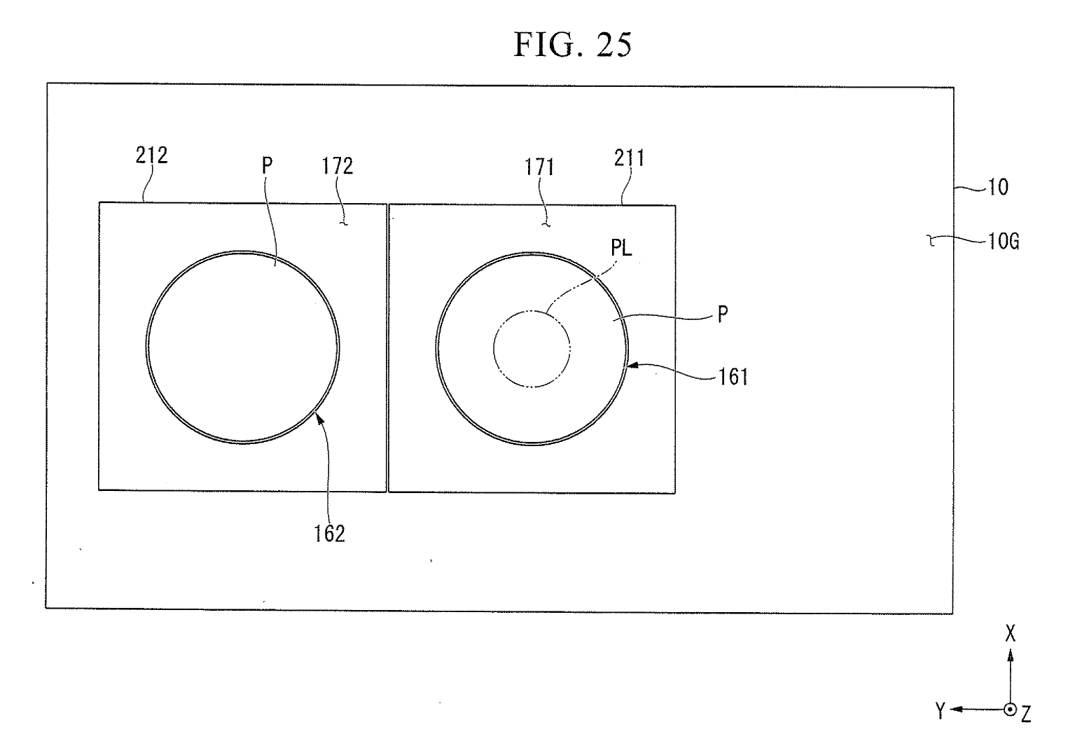

Furthermore, in each of the embodiments discussed above, the exposure apparatus EX (EX2) comprises the substrate stage 2 and the measurement stage 3; however, for example, as shown in FIG. 25, the exposure apparatus EX (EX2) may not comprise a measurement stage and instead may comprise a plurality of substrate stages 211, 212; furthermore, the substrate stages 211, 212 may comprise substrate holding parts 161, 162, respectively, that releasably hold the substrates P. Furthermore, examples of a twin stage type exposure apparatus that comprises a plurality of substrate stages without comprising a measurement stage are disclosed in U.S. Pat. No. 6,341,007, U.S. Pat. No. 6,208,407, U.S. Pat. No. 6,262,796, and the like. In a twin stage type exposure apparatus, the immersion space LS (LC) can be moved, while preventing leakage of the liquid, from the space above an upper surface 171 of the first substrate stage 211 to the space above an upper surface 172 of the second substrate stage 212, and vice versa, by synchronously moving the first substrate stage 211 and the second substrate stage 212 with respect to the emergent surface 13 and the lower surface 14 in the state wherein the upper surface 171 of the first substrate stage 211 and the upper surface 172 of the second substrate stage 212 are brought into close proximity or contact with one another. In this case, the cap member (30 and the like) explained in the first through sixth embodiments discussed above may be releasably held by at least one of the plurality of the substrate stages.

Furthermore, the exposure apparatus EX (EX2) may comprise a plurality of the substrate stages and the measurement stages. In this case, the cap member (30 and the like) explained in the first through sixth embodiments discussed above may be releasably held by at least one of the stages of the plurality of the substrate stages and the measurement stages.

In addition, the cap member (30 and the like) used in the maintenance sequence may be loaded from outside of the space wherein the exposure of the substrate P is performed. For example, the cap member (30 and the like) may be loaded to a holding part on the substrate stage 2 using a transport apparatus that transports the substrate P, the substrate stage 2 may be moved such that it opposes the cap member (30 and the like) and the lower surface 14 of the liquid immersion member 7, and the cap member (30 and the like) released from the holding part on the substrate stage 2 may be held by the holding part 50 (i.e., the prescribed member 44). In this case, the cap member (30 and the like) may be a circular substrate whose thickness and diameter are substantially equal to those of the substrate P. Alternatively, an operator may dispose the cap member (30 and the like) such that it opposes the lower surface 14 of the liquid immersion member 7. In this case, if the holding part 50 (i.e., the prescribed member 44) is not used in the holding of the cap member (30 and the like), then the holding part 50 (i.e., the prescribed member 44) may be omitted. In addition, the maintenance process of the 7 performed in the state where the cap member (30 and the like) held by the holding part 50 opposes the lower surface 14 of the liquid immersion member 7 is not limited to the cleaning process of the liquid immersion member 7, but may perform the temperature adjusting of the liquid immersion member 7 and the like.

Furthermore, in each of the embodiments discussed above, the optical path on the emergent (i.e., the image plane) side of the last optical element 12 of the projection optical system PL is filled with the first liquid LQ1; however, it is possible to use a projection optical system wherein the optical path on the incident (i.e., the object plane) side of the last optical element 12 is also filled with the first liquid LQ1, as disclosed in, for example, PCT International Publication No. WO2004/019128.

Furthermore, in each of the embodiments discussed above, water is used as the first liquid LQ1, but a liquid other than water may be used. It is preferable to use, as the first liquid LQ1, a liquid that is transparent with respect to the exposure light EL, has a high refractive index with respect to the exposure light EL, and is stable with respect to the projection optical system PL or the film of the photosensitive material (i.e., the photoresist) that forms the front surface of the substrate P. For example, it is also possible to use hydrofluoroether (HFE), perfluorinated polyether (PFPE), Fomblin® oil, or the like as the first liquid LQ1. In addition, it is also possible to use various fluids, for example, a supercritical fluid, as the first liquid LQ1.

Furthermore, the substrate P in each of the embodiments discussed above is not limited to a semiconductor wafer for fabricating semiconductor devices, but can also be adapted to, for example, a glass substrate for display devices, a ceramic wafer for thin film magnetic heads, or the original plate of a mask or a reticle (e.g., synthetic quartz or a silicon wafer) used by an exposure apparatus.

In addition to a step-and-scan system scanning type exposure apparatus (i.e., a scanning stepper) that scans and exposes the pattern of the mask M by synchronously moving the mask M and the substrate P, a step-and-repeat type projection exposure apparatus (i.e., a stepper) that exposes the full field of the pattern of the mask M, with the mask M and the substrate P in a stationary state, and sequentially steps the substrate P can also be adapted to the exposure apparatus EX.

Furthermore, when performing an exposure with a step-and-repeat system, the projection optical system is used to transfer a reduced image of a first pattern to the substrate P in a state wherein the first pattern and the substrate P are substantially stationary, after which the projection optical system may be used to perform a full-field exposure of the substrate P, wherein a reduced image of a second pattern partially superposes the transferred first pattern in a state wherein the second pattern and the substrate P are substantially stationary (i.e., as in a stitching type full-field exposure apparatus). In addition, the stitching type exposure apparatus can also be adapted to a step-and-stitch type exposure apparatus that successively steps the substrate P and transfers at least two patterns onto the substrate P such that they are partially superposed.

In addition, the present invention can also be adapted to, for example, an exposure apparatus that combines on a substrate the patterns of two masks through a projection optical system and double exposes, substantially simultaneously, a single shot region on the substrate using a single scanning exposure, as disclosed in, for example, U.S. Pat. No. 6,611,316. In addition, the present invention can also be adapted to, for example, a proximity type exposure apparatus and a mirror projection aligner.

The type of exposure apparatus EX is not limited to semiconductor element fabrication exposure apparatuses that expose the substrate P with the pattern of a semiconductor element, but is also widely applicable to, for example, exposure apparatuses for fabricating liquid crystal devices or displays and exposure apparatuses for fabricating thin film magnetic heads, image capturing devices (CCDs), micromachines, MEMS, DNA chips, reticles and masks, and the like.

Furthermore, in each of the embodiments discussed above, the position of each of the stages is measured using an interferometer system that comprises laser interferometers, but this is not limited thereto; for example, an encoder system that detects a scale (i.e., a diffraction grating) provided to each of the stages may be used.

Furthermore, in the embodiments discussed above, an optically transmissive mask wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, U.S. Pat. No. 6,778,257, may be used. In addition, instead of a variable shaped mask that comprises a non-emissive type image display device, a pattern forming apparatus that comprises a self-luminous type image display device may be provided.

Each of the embodiments discussed above explained an exemplary case of the exposure apparatus that comprises the projection optical system PL, but the present invention can be adapted to an exposure apparatus and an exposing method that do not use the projection optical system PL. For example, the immersion space can be formed between an optical member, such as a lens, and the substrate, and the exposure light can be radiated to the substrate through that optical member.

In addition, by forming interference fringes on the substrate P as disclosed in, for example, PCT International Publication No. WO2001/035168, the present invention can also be adapted to an exposure apparatus (i.e., a lithographic system) that exposes the substrate P with a line-and-space pattern.

The exposure apparatus EX according to the embodiments discussed above is manufactured by assembling various subsystems, as well as each constituent element, such that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus from the various subsystems includes, for example, the connection of mechanical components, the wiring and connection of electrical circuits, and the piping and connection of the pneumatic circuits among the various subsystems. Naturally, prior to performing the process of assembling the exposure apparatus from these various subsystems, there are also the processes of assembling each individual subsystem. When the process of assembling the exposure apparatus from the various subsystems is complete, a comprehensive adjustment is performed to ensure the various accuracies of the exposure apparatus as a whole. Furthermore, it is preferable to manufacture the exposure apparatus in a clean room wherein, for example, the temperature and the cleanliness level are controlled.

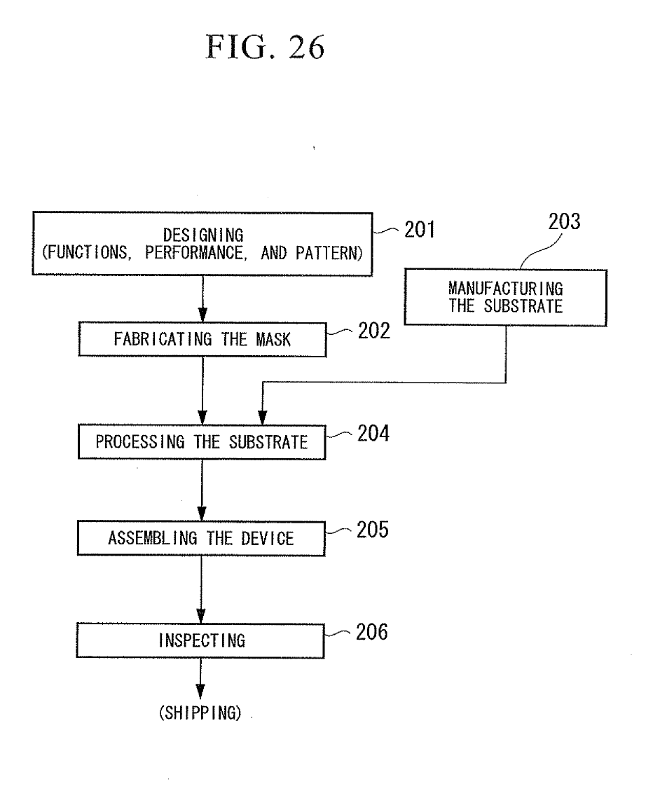

As shown in FIG. 26, a microdevice, such as a semiconductor device, is manufactured by: a step 201 that designs the functions and performance of the microdevice; a step 202 that fabricates a mask (i.e., a reticle) based on this designing step; a step 203 that manufactures a substrate, which is the base material of the device; a substrate processing step 204 that comprises a substrate process (i.e., an exposure process) that includes, in accordance with the embodiments discussed above, exposing the substrate with the exposure light from the mask pattern and developing the exposed substrate; a device assembling step 205 (which includes fabrication processes such as dicing, bonding, and packaging processes); an inspecting step 206; and the like. According to the embodiments discussed above, the substrate processing step includes the maintenance sequence, which cleans the liquid immersion member 7, and the exposure of the substrate P is performed using the cleaned liquid immersion member 7.

Furthermore, the features of each of the embodiments discussed above can be combined as appropriate. In addition, there may be cases wherein some of the constituent elements are not used. In addition, each disclosure of every Japanese published patent application and U.S. patent related to the exposure apparatus recited in each of the embodiments, modified examples, and the like discussed above is hereby incorporated by reference in its entirety to the extent permitted by national laws and regulations.

1. An exposure apparatus that exposes a substrate with exposure light, which transits a first liquid, comprising:
an optical member, which has an emergent surface wherefrom the exposure light emerges;
a liquid immersion member, which at least partly surrounds an optical path of the exposure light emerging from the emergent surface, has a lower surface that the substrate opposes during an exposure of the substrate, and holds the first liquid between the substrate and at least part of the lower surface; and
a plate member, which has a first surface and a second surface that faces the opposite direction to the first surface and which is capable of moving to a position at which it opposes the lower surface;
wherein,
cleaning is performed in a state wherein the first surface opposes the lower surface.

2. The exposure apparatus according to claim 1, further comprising:
a movable member, which has an upper surface and is capable of moving to a position at which the upper surface opposes the emergent surface; and
a first holding part, which is disposed in the movable member and releasably holds the plate member;
wherein,
the plate member is held by the first holding part.

3. The exposure apparatus according to claim 1, further comprising:
a second holding part that releasably holds the plate member released from the first holding part such that the first surface and the lower surface are opposed.

4. The exposure apparatus according to claim 3, wherein
the second holding part at least partly surrounds the lower surface.

5. The exposure apparatus according to claim 1, further comprising:
a movable member, which has an upper surface and is capable of moving to a position at which the upper surface opposes the emergent surface; and
a drive system, which moves the plate member to a space between the lower surface and the upper surface.

6. The exposure apparatus according to claim 5, wherein
the upper surface opposes the lower surface across a first gap and is capable of holding the first liquid between itself and the lower surface; and
a distance between the first surface and the second surface is smaller than the first gap.

7. The exposure apparatus according to claim 5, further comprising:
a liquid recovery port, which is provided to the movable member and is capable of recovering the first liquid.

8. The exposure apparatus according to claim 1,
wherein
the cleaning is performed by holding a second liquid between the first surface and the lower surface.

9. The exposure apparatus according to claim 8, further comprising:
a first supply port, which is disposed in the liquid immersion member and supplies the second liquid.

10. The exposure apparatus according to claim 8, further comprising:
a recovery port, which is disposed in the liquid immersion member and recovers at least some of the second liquid between the first surface and the lower surface.

11. The exposure apparatus according to claim 10, wherein
during the cleaning, the second liquid is supplied via the first supply port and an operation of recovering the second liquid via the recovery port is performed in parallel with an operation of supplying the second liquid via the first supply port.

12. The exposure apparatus according to claim 10, wherein
the recovery port includes a first recovery port, which is disposed on the outer side of the first supply port in the radial directions with respect to the optical path, and a second recovery port, which is disposed on the outer side of the first recovery port.

13. The exposure apparatus according to claim 12, wherein
during the exposure of the substrate, the first liquid is supplied via the first supply port and an operation of recovering the first liquid via the first recovery port is performed in parallel with an operation of supplying the first liquid via the first supply port.

14. The exposure apparatus according to claim 8, further comprising:
a first supply port, which supplies the first liquid during the exposure of the substrate; a first recovery port, which is disposed on the outer side of the first supply port in radial directions with respect to the optical path and recovers the first liquid during the exposure of the substrate; and
a second recovery port, which is disposed on the outer side of the first recovery port;
wherein,
during the cleaning, the second liquid is supplied via the first supply port, the second liquid is supplied via the first recovery port, and the second liquid is recovered via the second recovery port.

15. The exposure apparatus according to claim 12,
wherein
the lower surface includes a surface of a first porous member disposed in the first recovery port.

16. The exposure apparatus according to claim 8,
wherein
a second immersion space, which is formed with the second liquid between the first surface and the lower surface during the cleaning, is larger than a first immersion space, which is formed with the first liquid between the lower surface and the front surface of the substrate during the exposure of the substrate.

17. The exposure apparatus according to claim 8,
wherein
during the cleaning, the second liquid is supplied via a second supply port disposed in the plate member.

18. The exposure apparatus according to claim 17, wherein
the second supply port jets the second liquid toward the lower surface.

19. The exposure apparatus according to claim 8,
wherein
the plate member comprises an ultrasonic oscillator that imparts ultrasonic vibrations to the second liquid, which contacts with the plate member.

20. The exposure apparatus according to claim 8, further comprising:
an ultrasonic oscillator, which is disposed in the liquid immersion member and imparts ultrasonic vibrations to the second liquid contacting the liquid immersion member.

21. The exposure apparatus according to claim 8,
wherein
the first surface includes a first portion and a second portion, which protrudes than the first portion.

22. The exposure apparatus according to claim 8,
wherein
the first liquid and the second liquid are the same type of liquid.

23. The exposure apparatus according to claim 8,
wherein
the second liquid includes at least one fluid selected from the group consisting of an alkali and alcohol.

24. The exposure apparatus according to claim 8, further comprising:
a third recovery port, which is provided to the plate member and is capable of recovering at least one liquid selected from the group consisting of the first liquid and the second liquid.

25. The exposure apparatus according to claim 1,
wherein
the plate member comprises a reflective part, which reflects the exposure light emerging from the emergent surface; and
at least some of the exposure light reflected by the reflective part is radiated to the lower surface.

26. The exposure apparatus according to claim 1,
wherein
the plate member comprises a brush member, which is capable of brushing against the lower surface.

27. The exposure apparatus according to claim 1,
wherein
the plate member comprises a second porous member, which is capable of contacting the lower surface.

28. An exposure apparatus that exposes a substrate with exposure light, which transits a first liquid, comprising:
an optical member, which has an emergent surface wherefrom the exposure light emerges;
a liquid immersion member, which at least partly surrounds an optical path of the exposure light emerging from the emergent surface and has a lower surface that an object disposed at a position at which it opposes the emergent surface is capable of opposing;
a first movable member, which has a first upper surface and is capable of moving to a position at which the first upper surface is capable of opposing at least one surface selected from the group consisting of the emergent surface and the lower surface;
a second movable member, which has a second upper surface and is capable of moving to a position at which the second upper surface opposes at least one surface selected from the group consisting of the emergent surface and the lower surface;
a plate member, which is releasably held by a first holding part disposed in at least one member selected from the group consisting of the first movable member and the second movable member and which has a third upper surface;
wherein,
in a first process, the first liquid is held between the emergent surface and the lower surface on one side and at least one surface selected from the group consisting of the first upper surface, the second upper surface, and the third upper surface of the plate member held by the first holding part on the other side; and
in a second process, which differs from the first process, a second liquid is held between the lower surface and the third upper surface of the plate member released from the first holding part.

29. The exposure apparatus according to claim 28, wherein
the first movable member and the second movable member move synchronously with respect to the emergent surface and the lower surface in a state wherein the first upper surface and the second upper surface are brought into close proximity or contact with one another such that a space that is capable of holding the first liquid between the emergent surface and the lower surface on one side and at least one surface selected from the group consisting of the first upper surface and the second upper surface on the other side continues to be formed.

30. The exposure apparatus according to claim 28, wherein
the space on the emergent surface side that is filled with the first liquid is maintained while switching between the state wherein the space filled with the first liquid is formed between the first movable member and the emergent surface and the state wherein the space filled with the first liquid is formed between the second movable member and the emergent surface.

31. The exposure apparatus according to claim 30, wherein
the first movable member comprises a first substrate holding part, which releasably holds the substrate; and
the second movable member comprises a second substrate holding part, which releasably holds the substrate.

32. The exposure apparatus according to claim 30, wherein
the first movable member comprises a first substrate holding part, which releasably holds the substrate; and
a measuring instrument, which measures the exposure light, is mounted to the second movable member.

33. The exposure apparatus according to claim 28,
wherein
the first process includes the exposure of the substrate.

34. The exposure apparatus according to claim 28,
wherein
the second process includes cleaning.

35. The exposure apparatus according to claim 28,
wherein
in the second process, at least one member selected from the group consisting of the first movable member and the second movable member is moved to a third position, which is different from a first position.

36. The exposure apparatus according to claim 28, comprising:
a second holding part, which holds the plate member in the second process such that the emergent surface and the lower surface on one side and the third upper surface on the other side are opposed.

37. A device fabricating method, comprising:
exposing a substrate using an exposure apparatus according to claim 1, and
developing the exposed substrate.

38. An exposing method that exposes a substrate with exposure light, which transits a first liquid, the method comprising:
holding the first liquid between the substrate and at least part of a lower surface of a liquid immersion member, which at least partly surrounds an optical path of the exposure light emerging from an emergent surface of an optical member;
exposing the substrate with the exposure light that emerges from the emergent surface and transits the first liquid between the emergent surface and the substrate;
causing the lower surface and a first upper surface of a plate member held by a holding part to oppose one another;
holding the plate member, which has been released from the holding part, in the state wherein the first upper surface and the lower surface are opposed; and
cleaning the lower surface in the state wherein the lower surface and the first upper surface are opposed.

39. An exposing method, comprising:
holding a first liquid between a substrate held by a first movable member and at least part of a lower surface of a liquid immersion member, which at least partly surrounds an optical path of exposure light emerging from an emergent surface of an optical member;
exposing the substrate with the exposure light that emerges from the emergent surface and transits the first liquid between the emergent surface and the substrate;
in the first process, holding the first liquid between the emergent surface and the lower surface on one side and at least one surface selected from the group consisting of a first upper surface of the first movable member, a second upper surface of the second movable member, and a third upper surface of the plate member releasably held by a first holding part disposed in at least one member selected from the group consisting of the first movable member and the second movable member, on the other side; and
in a second process, which is different from the first process, holding a second liquid between the lower surface and the third upper surface of the plate member released from the first holding part.

40. A device fabricating method, comprising:
exposing a substrate using an exposing method according to claim 38, and
developing the exposed substrate.

41. A maintenance method of an exposure apparatus that exposes a substrate on a substrate stage with exposure light emerging from an emergent surface of an optical member, which transits a first liquid, the method comprising:
causing a lower surface of a liquid immersion member, which at least partly surrounds an optical path of the exposure light emerging from the emergent surface of the optical member and a first upper surface of a plate member held by the holding part of the substrate stage to oppose respectively; and holding the plate member released from the holding part of the substrate stage in the state wherein the first upper surface and the lower surface are opposed.

42. The maintenance method according to claim 41, further comprising:
loading the plate member to the holding part using a transport apparatus that transports the substrate.

43. The maintenance method according to claim 41, further comprising:
performing a maintenance of the substrate in the state wherein the first upper surface of the plate member released from the holding part of the substrate stage and the lower surface are opposed.

44. The maintenance method according to claim 41, further comprising:
cleaning the substrate in the state wherein the first upper surface of the plate member released from the holding part of the substrate stage and the lower surface are opposed.

45. The maintenance method according to claim 41, further comprising:
cleaning the liquid immersion member in the state wherein the first upper surface of the plate member released from the holding part of the substrate stage and the lower surface are opposed.

46. The maintenance method according to claim 41,
wherein
the plate member is a circular shape substrate being substantially equal to the substrate in the diameter.

47. The maintenance method according to claim 41,
wherein
the plate member is a circular shape substrate being substantially equal to the substrate in the thickness.
